(19) United States
(12) Patent Application Publication
(10) Pub. No.: US 2025/0277968 A1
(43) Pub. Date: Sep. 4, 2025

(54) MOVABLE DEVICE, IMAGE PROJECTION DEVICE, MOVING OBJECT, HEAD-MOUNTED DISPLAY, HEAD-UP DISPLAY, LASER HEADLAMP, OBJECT RECOGNITION DEVICE, AND OBJECT RECOGNITION APPARATUS, AND EYE TRACKING APPARATUS

(71) Applicants: Yosuke ABE, Tokyo (JP); Shuichi SUZUKI, Tokyo (JP); Tsuyoshi HASHIGUCHI, Tokyo (JP)

(72) Inventors: Yosuke ABE, Tokyo (JP); Shuichi SUZUKI, Tokyo (JP); Tsuyoshi HASHIGUCHI, Tokyo (JP)

(21) Appl. No.: 19/066,532

(22) Filed: Feb. 28, 2025

(30) Foreign Application Priority Data
Feb. 29, 2024 (JP) 2024-029671

(51) Int. Cl. G02B 26/08; G02B 26/10

(52) U.S. Cl. CPC G02B 26/0858; G02B 26/10

(57) ABSTRACT

A movable device includes a movable portion, a driver to drive the movable portion, a first connect beam extending from the movable portion in a direction intersecting the center line of the movable portion. Further, there is a second connect beam extending from the driver in a direction intersecting the centerline of the movable portion, and an intermediate connector extending in a direction along the centerline and connecting the first connect beam and the second connect beam.

### CROSS-REFERENCE TO RELATED APPLICATION

This patent application is based on and claims priority pursuant to 35 U.S.C. § 119(a) to Japanese Patent Application No. 2024-029671, filed on Feb. 29, 2024, in the Japan Patent Office, the entire disclosure of which is hereby incorporated by reference herein.

### BACKGROUND

### Technical Field

This present disclosure relates to a mobile device, a projection device, a moving object, a head-mounted display, a head-up display, a laser headlamp, an object recognition device, and a position detection device.

### Related Art

A movable device such as a micro electro mechanical systems (MEMS) device manufactured by micromachining silicon or glass is known.

For example, in the related art, the technology in this field has been proposed that includes a mirror structure comprising (A) a mirror body and a mirror with a light reflecting layer provided on the surface of the mirror body, (B) a plurality of pillars with the upper end fixed to the back surface of the mirror body, (C) a displacement portion with one end fixed to the lower end of the respective pillar, and (D) a support portion with the other end of the displacement portion fixed.

However, in a movable device such as proposed in the related art, the rigidity is high to prevent distortion of the reflective surface. Therefore, in the related art, the reaction force applied to the mirror was not damped, resulting in suppression of the displacement of the mirror in the centerline direction, causing a decrease in the oscillation angle.

### SUMMARY

According to an embodiment of the present disclosure, a movable device includes a movable portion, a driver to drive the movable portion, and a first connect beam extending from the movable portion in a direction intersecting the center line of the movable portion. Further, there is a second connect beam extending from the driver in a direction intersecting the centerline of the movable portion, and an intermediate connector extending in a direction along the centerline and connecting the first connect beam and the second connect beam.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a plan view of a movable device according to a first embodiment of the present disclosure;

FIG. 2A is a cross-sectional view along the second axis L12 in FIG. 1;

FIG. 2B is a cross-sectional view along the second axis L11 in FIG. 1;

FIG. 3 is a cross-sectional view of a support portion, a driver, and a part of the connector, and the cross-sectional view along the second axis L12 in FIG. 1;

FIG. 4 is a cross-sectional view of a mirror and the part of the connector;

FIG. 5A is a schematic diagram of the movable device for a comparative example, illustrating the state of the movable device when not driven;

FIG. 5B is a schematic diagram of the movable device for a comparative example, illustrating the state of the movable device when driven;

FIG. 6 is a schematic diagram of the mirror, the connector, and the driver, illustrating the state in which the reflective surface is inclined;

FIG. 7 is a plan view of the movable device according to a second embodiment of the present disclosure;

FIG. 8 is a cross-sectional view of the movable device according to a third embodiment of the present disclosure;

FIG. 9 is a cross-sectional view of the movable device according to a fourth embodiment of the present disclosure, illustrating a cut plane along the second axis L12;

FIG. 10 is a plan view of the mirror, the connector, and a part of the driver;

FIG. 11 is a cross-sectional view of the part of the connector and the driver;

FIG. 12 is a cross-sectional view of the movable device according to the fifth embodiment of the present disclosure;

FIG. 13 is a schematic diagram of the movable device according to the sixth embodiment of the present disclosure;

FIG. 14 is a schematic diagram illustrating an example of an light scan system;

FIG. 15 is a diagram illustrating a hardware configuration of a light scan system;

FIG. 16 is a functional block diagram illustrating an example of a control device;

FIG. 17 is a flowchart of an example of a process related to a light scan system;

FIG. 18 is a schematic diagram illustrating an example of an automobile including a head-up display apparatus;

FIG. 19 is a schematic diagram illustrating an example of a head-up display apparatus;

FIG. 20 is a schematic diagram illustrating an example of an image forming apparatus including an optical writing device;

FIG. 21 is a schematic diagram illustrating an example of an optical writing device;

FIG. 22 is a schematic diagram illustrating an example of an automobile including a laser imaging detection and ranging apparatus;

FIG. 23 is a schematic diagram illustrating an example of an automobile including a laser imaging detection and ranging apparatus;

FIG. 24 is a schematic diagram illustrating an example of a laser imaging detection and ranging apparatus;

FIG. 25 is a schematic diagram illustrating an example of a configuration of a laser headlamp;

FIG. 26 is a schematic perspective view of an example of a configuration of a head-mounted display;

FIG. 27 is a schematic diagram illustrating an example of a portion of a configuration of a head-mounted display;

FIG. 28 is a schematic diagram illustrating an example of a pupil-or-cornea position detection apparatus; and

FIG. 29 is a schematic diagram illustrating an example of a pupil-or-cornea position detection apparatus mounted on a head-mounted display.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

The following is a description of the embodiment of the invention with reference to the drawings. In each drawing, the same reference signs are attached to the same configuration parts, and redundant description is appropriately simplified or omitted.

In the description of the following embodiments, pivoting, oscillating, and movable are to be considered synonymous. In each drawings, the mutually orthogonal X-axis, Y-axis, and Z-axis directions may be illustrated. The Z-axis direction is along the stacking direction of each layer in the piezoelectric driving portion. A view in the Z-axis direction may be described as a “plan view. In each drawing, a parallel oblique line may be added to a portion that is not a cross-section.

The X-axis direction includes the direction indicated by the arrow and vice versa; the direction in the X-axis direction to which the arrow points may be described as the +X direction and the direction opposite to the +X direction as the −X direction. The Y-axis direction includes the direction indicated by the arrow and vice versa; the direction in the Y-axis direction to which the arrow points may be described as the +Y direction and the direction opposite to the +Y direction as the −Y direction. The Z-axis direction includes the direction indicated by the arrow and vice versa; the direction in the Z-axis direction to which the arrow points may be described as the +Z direction and the direction opposite to the +Z direction as the −Z direction.

The terms “upper” and “lower” may also be used. The term “upper” may be in the +Z direction, and “lower” may be in the −Z direction. These directions do not limit the orientation of the movable device 13, and the orientation of the movable device 13 is arbitrary. The movable device may be called a “light deflector”.

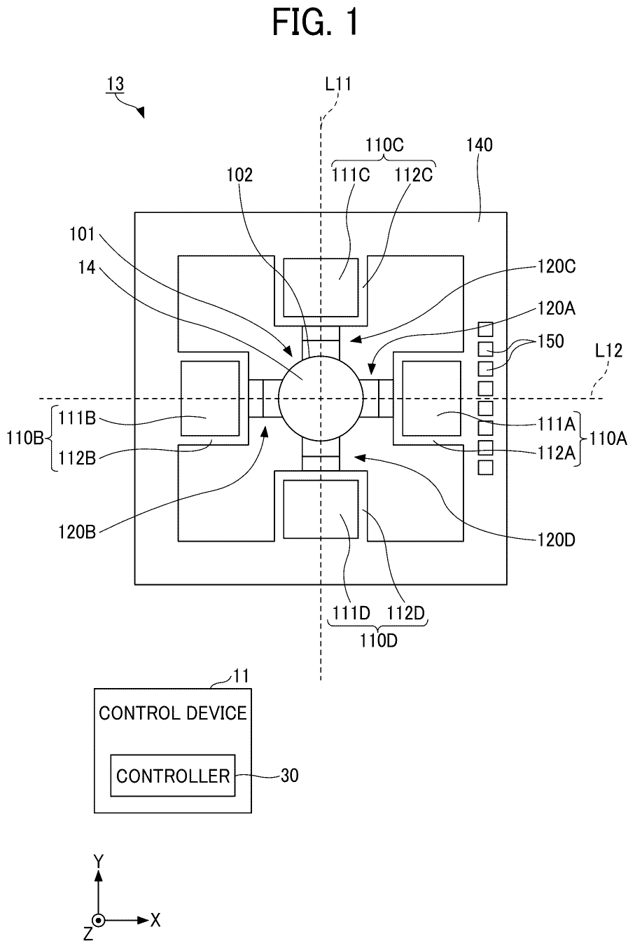

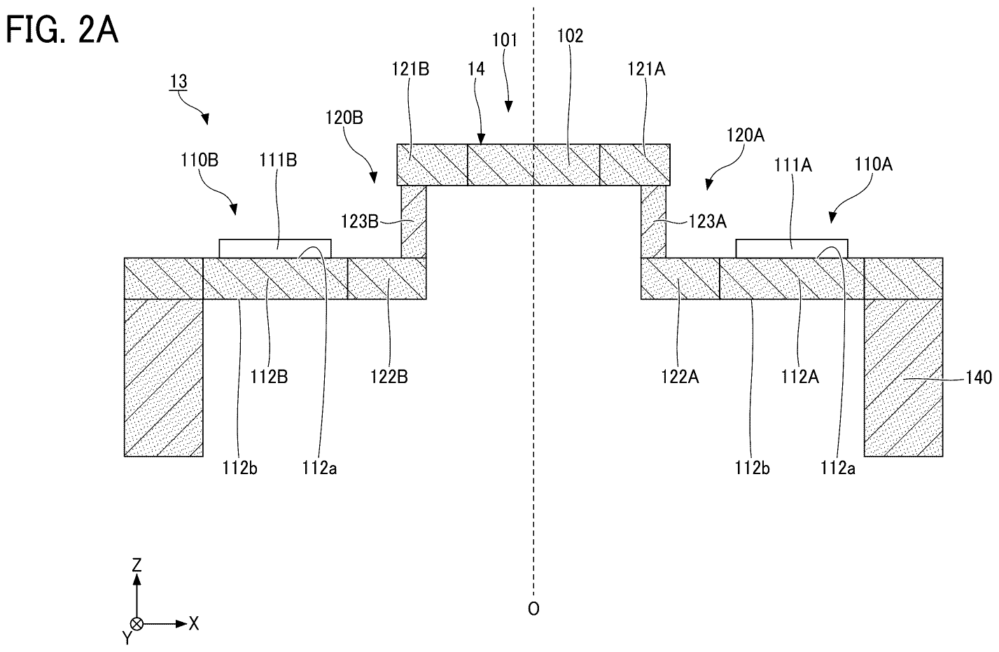

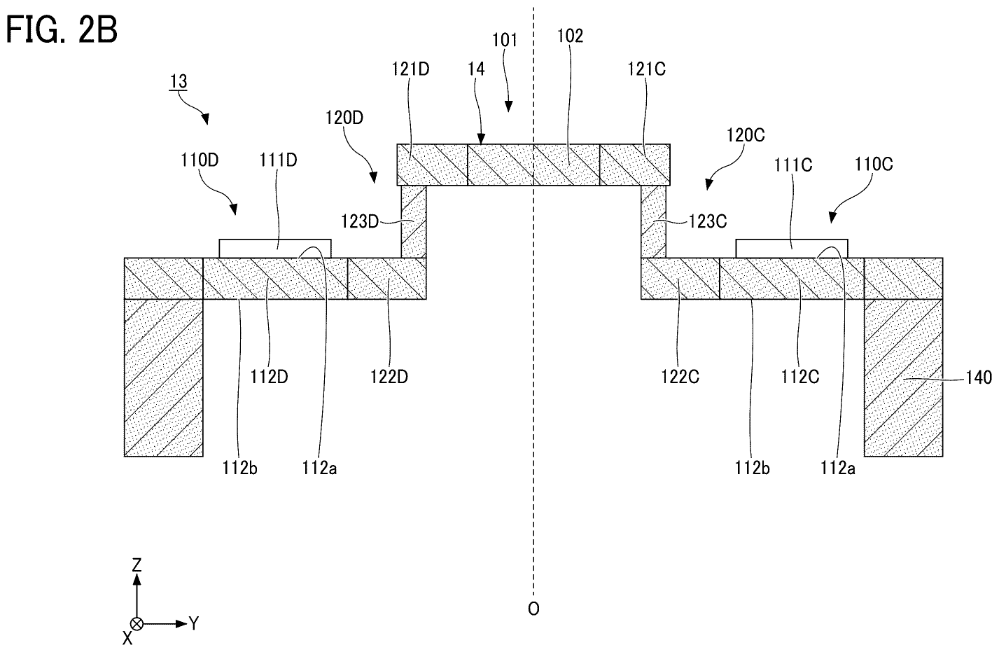

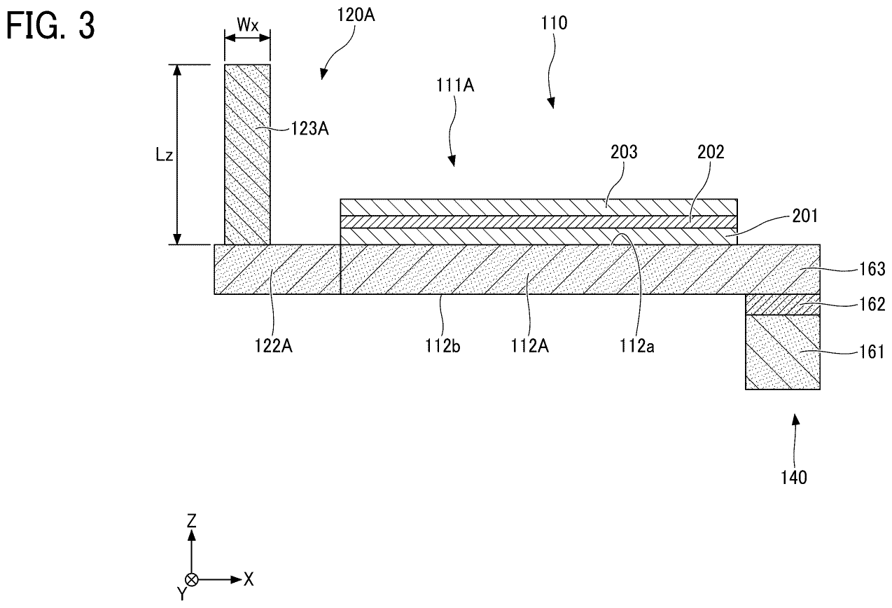

The movable device 13 according to the first embodiment will be described with reference to FIGS. 1 to 3. FIG. 1 is a plan view of a movable device according to a first embodiment of the present disclosure. FIG. 2A is a cross-sectional view along the second axis L12 in FIG. 1. FIG. 2B is a cross-sectional view along the second axis L11 in FIG. 1. FIG. 3 is a cross-sectional view of a support portion, a driver, and a part of the connector, and the cross-sectional view along the second axis L12 in FIG. 1.

As illustrated in FIG. 1, the movable device 13 has a mirror 101, drivers 110A, 110B, 110C, and 110D, connectors 120A, 120B, 120C, and 120D, and a support portion 140.

The mirror 101 has a reflective surface 14 that reflects incident light. The mirror 101 is an example of a movable portion. The mirror 101 has, for example, a disk-shaped mirror base (movable base) 102 and the reflective surface 14 formed on the mirror base 102. The reflective surface 14 is formed on the +Z side of the mirror base 102. The mirror base 102 forms, for example, a disk shape.

The support portion 140 forms a rectangular frame, viewed in the Z-axis direction. The mirror 101 is located at the center of the support portion 140 as viewed in the Z-axis direction. The support portion 140 supports the mirror 101 via a plurality of drivers 110A, 110B, 110C, and 110D and connectors 120A, 120B, 120C, and 120D.

The movable device 13 includes an electrode connector 150 that is electrically connected to the drivers 110A, 110B, 110C, and 110D. The electrode connector 150 has a plurality of pads.

The drivers 110A, 110B, 110C, and 110D are supported by the support portion 140. The drivers 110A, 110B, 110C, and 110D extend inward from each side of the rectangular support portion 140 as viewed in the Z-axis direction. Here, the side closer to the mirror 101 is the inner side, and the side farther from the mirror 101 is the outer side.

The drivers 110A and 110B are arranged along the X-axis direction. The driver 110C and 110D are arranged along the Y-axis direction. The mirror 101 is disposed between the drivers 110A and 110B in the X-axis direction. The mirror 101 is disposed between the drivers 110C and 110D in the Y-axis direction.

The drivers 110A, 110B, 110C, and 110D are connected to the mirror 101 via the corresponding connectors 120A, 120B, 120C, and 120D, respectively. The drivers 110A and 110B oscillate the mirror 101 around the first axis L11 parallel to the Y-axis. The drivers 110C and 110D oscillate the mirror 101 around a second axis L12 parallel to the X-axis.

As illustrated in FIG. 2A, the driver 110A includes a piezoelectric element 111A and a base 112A. The piezoelectric element 111A is disposed on an upper surface 112a of the base 112A. The driver 110B includes a piezoelectric element 111B and a base 112B. The piezoelectric element 111B is disposed on the upper surface 112a of the base 112B. As illustrated in FIG. 2B, the driver 110C includes a piezoelectric element 111C and a base 112C. The piezoelectric element 111C is disposed on the upper surface 112a of the base 112C. The driver 110D includes a piezoelectric element 111D and a base 112D. The piezoelectric element 111D is disposed on the upper surface 112a of the base 112D. The upper surface 112a is an example of one of a pair of surfaces facing each other in the direction in which the centerline O of the base 112A and 112B extends. The lower surface 112b is a surface opposite the upper surface 112a. The drivers 110A, 110B, 110C, and 110D drive the mirror 101 (movable portion).

The connector 120A connects the mirror 101 to the driver 110A. the connector 120B connects the mirror 101 and the driver 110B. the connector 120C connects the mirror 101 and the driver 110C. and the connector 120D connects the mirror 101 and the driver 110D. The connector 120A and 120B are arranged along the X-axis direction. The connector 120C and 120D are arranged along the Y-axis direction.

As illustrated in FIG. 2A, the connector 120A includes a first connect beam 121A, a second connect beam 122A, and an intermediate connector 123A. The connector 120B includes a first connect beam 121B, a second connect beam 122B, and an intermediate connector 123B. As illustrated in FIG. 2B, the connector 120C includes a first connect beam 121C, a second connect beam 122C, and an intermediate connector 123C. The connector 120D includes a first connect beam 121D, a second connect beam 122D, and an intermediate connector 123D.

The first connect beams 121A and 121B extend from the mirror 101 in the X-axis direction. The first connect beams 121A and 121B extend in opposite directions. The first connect beams 121A and 121B are formed as an integral part of the mirror base 102. The first connect beams 121A and 121B are formed to overhang from the mirror base 102. The first connect beams of the connectors 120C and 120D include the same structure as the first connect beams 121A and 121B, and are not described here.

The second connect beam 122A extends in the X-axis direction from the drive 110A to the mirror 101. The second connect beam 122A is formed as an integral part of the base 112A. The second connect beam 122A is formed to overhang from the base 112A.

The second connect beam 122B extends out in the X-axis direction from the driver 110B toward the mirror 101. The second connect beam 122B is formed as an integral part of the base 112B. The second connect beam 122B is formed to extend out from the base 112B.

The second connect beam 122C and 122D include the same structure as the second connect beams 122A and 122B, so the description is omitted.

The intermediate connector 123A extends in the Z-axis direction and connects the first connect beam 121A to the second connect beam 122A. The intermediate connector 123A is, for example, columnar. The columnar shape may be cylindrical or prismatic. The upper end of the intermediate connector 123A may be connected to the end of the first connect beam 121A that is farther from the mirror 101. The lower end of the intermediate connector 123A may be connected to the end of the second connect beam 122A that is farther from the base 112A. The intermediate connector 123A extends from the second connect beam 122A in the +Z direction.

The intermediate connector 123B extends in the Z-axis direction and connects the first connect beam 121B to the second connect beam 122B. The intermediate connector 123B is, for example, columnar. The columnar shape may be cylindrical or prismatic. The upper end of the intermediate connector 123B may be connected to the end of the first connect beam 121B that is farther from the mirror 101. The lower end of the intermediate connector 123A may be connected to the end of the second connect beam 122B that is farther from the base 112B. The intermediate connector 123B extends from the second connect beam 122B in the +Z direction. As illustrated in FIG. 3, the length Lz and width Wx of the intermediate connector 123A satisfy the relationship Lz/Wx>1. In other words, the value of the length Lz of the intermediate connector 123A is greater than the value of the width Wx (Lz>Wx). The width Wx can be the length of the intermediate connector 123A in the x-axis direction or the diameter of the columnar intermediate connector 123A.

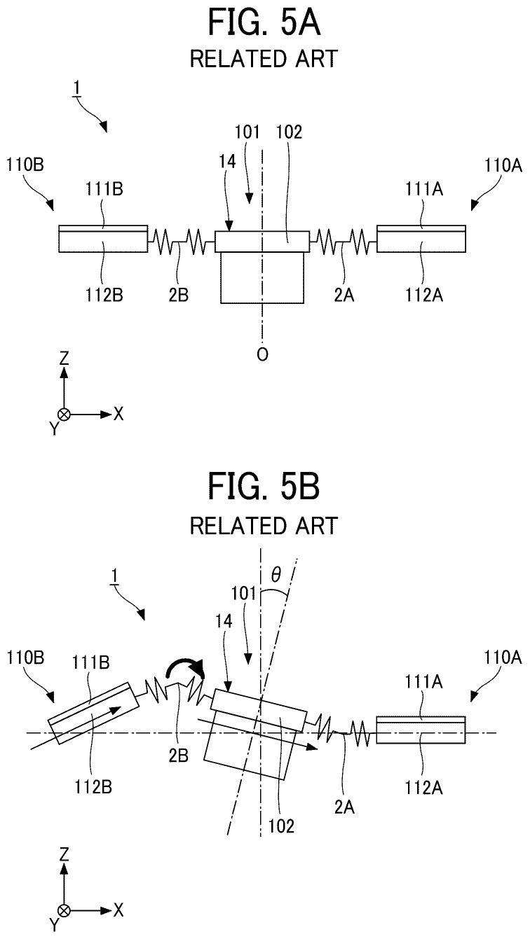

For example, if the relationship Lz/Wx=1 is satisfied, the rotation of the intermediate connector 123A causes a decrease in the displacement of the mirror 101 in the Z-axis direction, which counteracts the displacement in the Z-axis direction generated by the driver 110A. As a result, the oscillation angle θ of the mirror 101 decreases. An example of the oscillation angle θ is illustrated in FIGS. 5A and 5B which are explained in further detail below.

The intermediate connectors 120C and 120D have the same structure as the intermediate connectors 123A and 123B. The structures of intermediate connectors 120C and 120D are omitted.

The mirror 101, drivers 110A, 110B, 110C, and 110D, connectors 120A, 120B, 120C, and 120D, and support portion 140 are formed from an SOI (Silicon On Insulator) substrate, for example, by applying an etching process, etc. to the SOI substrate, The mirror 101, drivers 110A, 110B, 110C, and 110D, connectors 120A, 120B, 120C, and 120D, and support portion 140 are formed from the SOI substrate.

On the formed SOI substrate, a reflective surface 14, and piezoelectric elements 111A, 111B, 111C, and 111D, and electrode connector 150 are formed. The reflective surface 14, and piezoelectric elements 111A, 111B, 111C, and 111D, and electrode connector 150 are formed integrally with the SOI substrate. The reflective surface 14, and the piezoelectric elements 111A, 111B, 111C, and 111D, and the electrode connector 150 may be formed after the SOI substrate is formed, or may be formed during the forming of the SOI substrate.

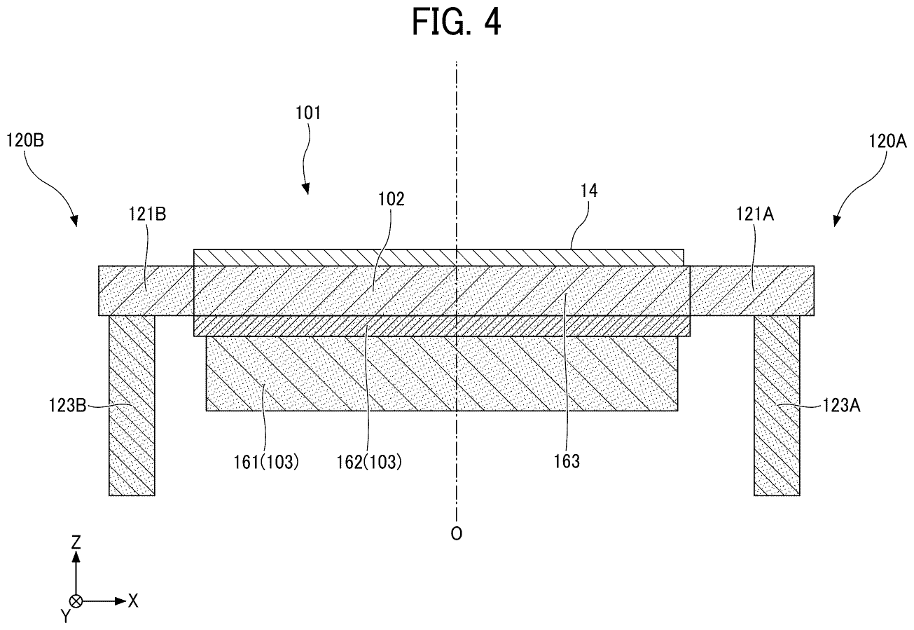

The SOI substrate includes a silicon support layer 161 made of single-crystal silicon (Si), a silicon oxide layer 162 formed on the silicon support layer 161 (+Z direction side), and a silicon active layer 163 made of single-crystal silicon formed on the silicon oxide layer 162, as illustrated in FIGS. 3 and 4. The silicon oxide layer 162 can be referred to as a BOX (Buried Oxide) layer.

A member composed only the silicon active layer 163 functions as an elastic part having elasticity. The support portion 140 includes a silicon support layer 161, a silicon oxide layer 162, and a silicon active layer 163. The bases 112A, 112B, and 112C, and 112D include a silicon active layer 163.

The SOI substrate may not be planar and may have curvature. The components used to form the movable device 13 can be integrally formed by etching process and may be partially elastic substrates. The movable device 13 and are not limited to SOI substrates.

As illustrated in FIG. 4, the mirror base 102 includes, for example, a silicon active layer 163. The reflective surface 14 includes a thin metal film including, for example, aluminum, gold, silver.

A movable thick-walled portion 103 for reinforcing the mirror portion is formed on the −Z side of the mirror portion base 102. The movable thick portion 103 includes, for example, a silicon support layer 161 and a silicon oxide layer 162. The movable thick portion 103 can suppress distortion of the reflective surface 14 caused by movement.

As illustrated in FIG. 3, the second connect beam 122A includes a silicon active layer 163. The second connect beam 122A is formed as an integral part of the silicon active layer 163 of the base 112A. The second connect beam 122A and the base 112A may be formed from a single SOI substrate, for example.

As illustrated in FIG. 4, the first connect beams 121A and 121B include the silicon active layer 163. The first connect beams 121A and 121B are formed as an integral part of the silicon active layer 163 of the mirror base 102. The first connect beams 121A, 121B and the mirror base 102 may be formed from a single SOI substrate, for example.

The intermediate connectors 123A, and 123B include, for example, a silicon active layer 163. The intermediate connectors 123A and 123B may be formed separately from the first connect beams 121A and 121B and the second connect beams 122A and 122B. The intermediate connector 123A may be bonded to the first connect beam 121A and the second connect beam 122A, respectively. The intermediate connector 123B may be bonded to the first connect beam 121B and the second connect beam 122B, respectively. The intermediate connectors 123A, 123B are bonded to the first connect beams 121A and 121B and the second connect beams 122A and 122B using an adhesive, such as a thermosetting resin or a light-curing resin.

The connectors 120A, 12B, 120C, and 120D can be fabricated using other specialized wafers or specialized processes. For example, two wafers can be joined to form a structure with two active layers.

As illustrated in FIG. 3, piezoelectric elements (piezoelectric portions) 111A, 111B, 111C, and 111D include a lower electrode 201, a piezoelectric layer 202, and an upper electrode 203. The lower electrodes 201 are stacked on the bases 112A, 112B, 112C, and 112D. The piezoelectric layer 202 is stacked on the lower electrode 201. The upper electrode 203 is stacked on the piezoelectric layer 202. The piezoelectric layer 202 is sandwiched between the lower electrode 201 and the upper electrode 203 in the Z-axis direction. The lower electrode 201 and the upper electrode 203 include, for example, gold (Au) or platinum (Pt). The piezoelectric layer 202 includes, for example, a piezoelectric material, PZT (lead zirconate titanate).

The electrode connector 150 is formed on the surface of the support portion 140. The electrode connector 150 is electrically connected to the lower electrode 201 and the upper electrode 203 of the piezoelectric elements 111A, 111B, 111C, and 111D. the electrode wiring connecting the lower electrode 201 and the upper electrode 203 to the electrode connector 150 is formed on the top surface of the support portion 140. The electrode wiring is formed from aluminum (Al), for example. The lower electrode 201 and the upper electrode 203 are electrically connected to a control device 11 via the electrode wiring and the electrode connector 150. The control device 11 applies a signal voltage to the lower electrode 201. The upper electrode 203 is grounded (GND).

An insulating layer comprising a silicon oxide film may be formed on the +Z side of the upper electrode 203 and on at least one of the +Z side of the support portion 140.

When electrode wiring is formed on the insulating layer, the insulating layer is not formed on the portion where the upper electrode 203 is connected to the electrode wiring and the portion where the lower electrode 201 is connected to the electrode wiring. Since the insulating layer is formed, the degree of freedom in designing the drivers 110A, 110B, 110C, and 110D and electrode wiring can be increased. Since the insulating layer is formed, short circuits caused by contact between electrodes can be suppressed. The silicon oxide film also functions as an antireflection material.

The movable device 13 may include piezoelectric elements for detection that detects elastic deformation of the drivers 110A, 110B, 110C, and 110D respectively.

The piezoelectric element 111A deforms the base 112A in response to an applied drive voltage. Similarly, the piezoelectric element 111B deforms the base 112B in response to the applied drive voltage. The piezoelectric element 111C deforms the base 112C in response to the applied drive voltage. The piezoelectric element 111D deforms the base 112D in response to the applied drive voltage.

The piezoelectric elements for detection output detection signals due to the piezoelectric effect in response to the deformation of the bases 112A, 112B, 112C, and 112D. The piezoelectric elements for detection output the detection signals to the control device 11 via the electrode connector 150.

FIG. 5A is a schematic diagram of the movable device for a comparative example, illustrating the state of the movable device when not driven. The movable device 1 for the comparative example has a mirror 101, drive sections 110A and 110B, and connect beams 2A and 2B. The connect beam 2A extends in the X-axis direction and connects the mirror 101 and the driver 110A. The connect beam 2B extends in the X-axis direction and connects the mirror 101 and the driver 110B. the connect beams 2A and 2B do not include a first connect beam, a second connect beam, or an intermediate connector.

As illustrated in FIG. 5A, in the non-driven state, the centerline O along the direction orthogonal to the reflective surface 14 is along the Z-axis direction. As illustrated in FIG. 5B, in the driven state, the centerline O is inclined with respect to the Z-axis. In the movable device 1, the drivers 110A and 110B can be driven to bend and deform the connect beams 2A and 2B into an arch shape, thereby displacing the swing angle θ of the mirror 101.

The movable device 1 needs to improve the energy efficiency when oscillating the mirror 101. In the mover 1, if the drivers 110A and 110B are driven by applying a large voltage to the drivers 110A and 110B, the oscillation angle θ can naturally be increased. However, as the displacement of the drivers 110A and 110B increases, energy loss increases, and the movable device needs to improve energy efficiency.

In order to reduce the loss due to bending deformation in connect beams 2A and 2B, it is conceivable to fabricate connect beams 2A and 2B with soft materials. However, in the technical field of the movable device (optical deflector) 1 using micromachining technology, it is common to fabricate the entire movable device 1 with hard materials such as silicon.

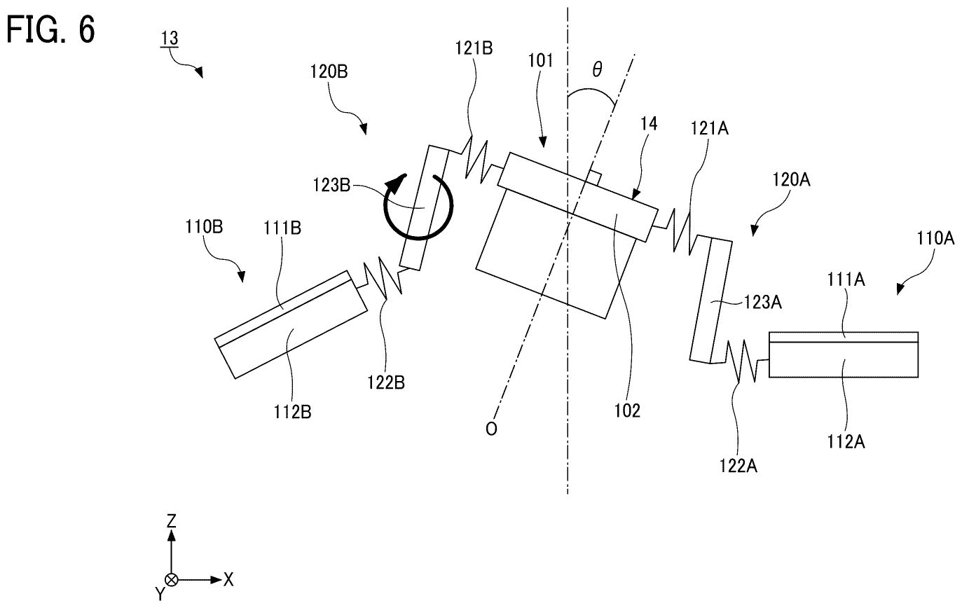

FIG. 6 is a schematic diagram of the mirror, the connector, and the driver, illustrating the state in which the reflective surface is inclined. The connectors 120A and 120B of the movable device 13 include the first connect beams 121A and 121B, the second connect beams 122A and 122B, and the intermediate connectors 123A and 123B. In the movable device 1 of the comparative example of FIGS. 5A and 5B, the displacement of the mirror 101 to the swing angle was achieved by bending the connect beams 2A and 2B. In the movable device 13, the rotation of the intermediate connectors 123A and 123B can replace part of the bending of the connect beams 2A and 2B. Therefore, the movable device 13 can reduce the bending of rigid members, an operation that requires a large amount of energy. This allows the movable device 13 to efficiently oscillate the mirror 101. The movable device 13 can oscillate the mirror 101 with less energy than the movable device 1.

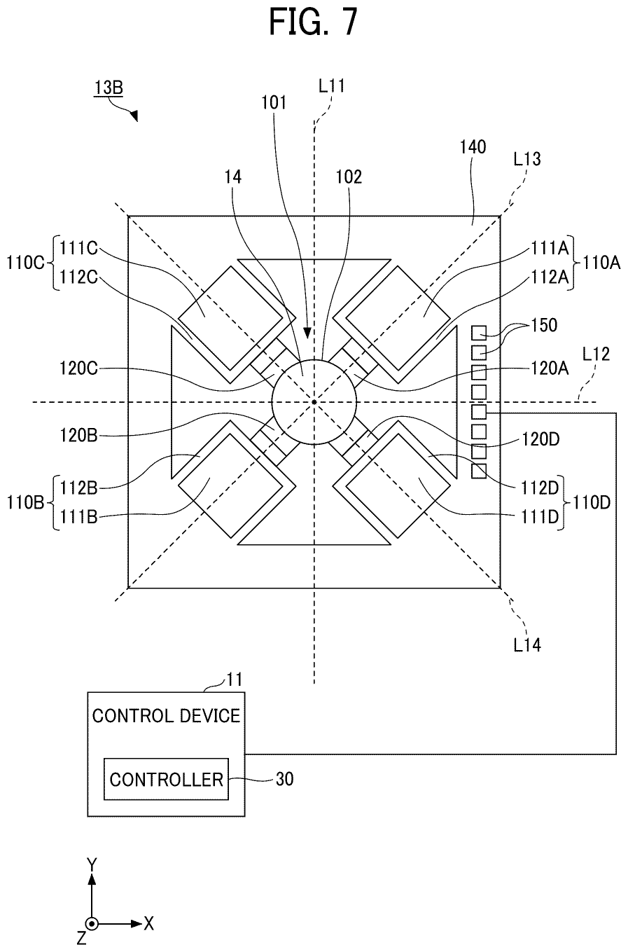

The control by the control device 11 illustrated in FIG. 7 will be described. The control device 11 may have a controller 30 that is electrically connected to the electrode connector 150 and applies a drive voltage to the piezoelectric elements 111A, 111B, 111C, and 111D of the movable device 13. As illustrated in FIG. 7, one of the pads of the electrode connector 150 is connected to the controller 30, however all or part of the pads may be connected to the controller 30.

The piezoelectric elements 111A, 111B, 111C, and 111D deform (e.g., expand or contract) in proportion to the potential of the applied voltage when a positive or negative voltage is applied in the polarization direction, and what is called reverse piezoelectric effect. The drivers 110 move the mirror 101 by utilizing the reverse piezoelectric effect.

In this case, the angle formed by the XY plane and the reflective surface 14 when the reflective surface 14 of the mirror 101 is inclined in the +Z or −Z direction relative to the XY plane is referred to as a deflection angle. A direction in which the +X-side of the mirror 101 is tilted in the +Z-direction is defined as a positive deflection angle, and a direction in which the +X-side of the mirror 101 is tilted in the −Z-direction is defined as a negative deflection angle.

In the drivers 110A and 110B, the respective piezoelectric layers 202 are deformed when drive voltages are applied to the piezoelectric layers 202 in parallel via the lower electrodes 201 and upper electrodes 203. The action of this deformation of the piezoelectric layers 202 causes the base 112A and 112B to flex and deform. As a result, a driving force around the first axis L11 acts on the mirror 101 through the twisting of the two connectors 120A and 120B, and the mirror 101 oscillates around the first axis L11. The drive voltage applied to the drive sections 110A and 110B is controlled by the control device 11.

The control device 11 can make the mirror 101 oscillates around the first axis L11 with the period of the predetermined sinusoidal waveform drive voltage, by applying drive voltages of predetermined sinusoidal waveforms to the piezoelectric elements 111A and 111B in parallel.

The control device 11 and any control device or controller may be implemented using a processor, processing circuitry, or circuitry, which are described below.

For example, when the frequency of the drive voltage is set to approximately 20 kHz, which is the same as the resonant frequency of the connectors 120A and 120B, the mirror 101 can be made to resonate and vibrate at approximately 20 kHz by utilizing the mechanical resonance generated by the twisting of the connections 120A and 120B.

The movable device 13 of the first embodiment may be of a cantilever type in which the base 112A and the connector 120A extend from the support portion 140 toward the X-axis direction. The movable device 13 is not limited to the cantilever type. The movable device 13 need only be capable of oscillating the mirror 101 by the piezoelectric layer 202A to which a drive voltage is applied. The movable device 13 may, for example, be of a double-ended support (double-held) type.

A movable device 13B according to the second embodiment will be described. FIG. 7 is a plan view of the movable device according to a second embodiment of the present disclosure. The difference between the movable device 13B according to the second embodiment and the movable device 13 according to the first embodiment is that an arrangement of the driving sections 110A, 110B, 110C, and 110D and the connectors 120A, 120B 120C, and 120D is different. In the following description of the second embodiment, descriptions similar to those of the first embodiment are omitted.

The plurality of drivers 110A, 110B, 110C, and 110D are arranged in positions corresponding to the corners of the rectangular support portion 140. In FIG. 7, the third axis L13 and the fourth axis L14 are illustrated, which intersect the first axis L11 and the second axis L12 at an angle of 45 degrees. The third axis L13 and the fourth axis L14 are orthogonal to each other. The third axis L13 and fourth axis L14 may be diagonals of the rectangular support portion 140.

The driver 110A and the driver 110B face each other in the direction in which the third axis L13 extends. The driving portion 110C and driving portion 110D face each other in the direction in which the fourth axis L14 extends. The connectors 120A and 120B extend out from the mirror 101 in the direction in which third axis L13 extends. The connectors 120C and 120D extend out from the mirror 101 in the direction in which the fourth axis L14 extends.

The movable device 13B according to the second embodiment has the same effect as the movable device 13 according to the first embodiment. The plurality of drive sections 110A, 110B, 110C, and 110D, and connectors 120A, 120B, 120C, and 120D may be arranged along the third axis L13 or the fourth axis L14.

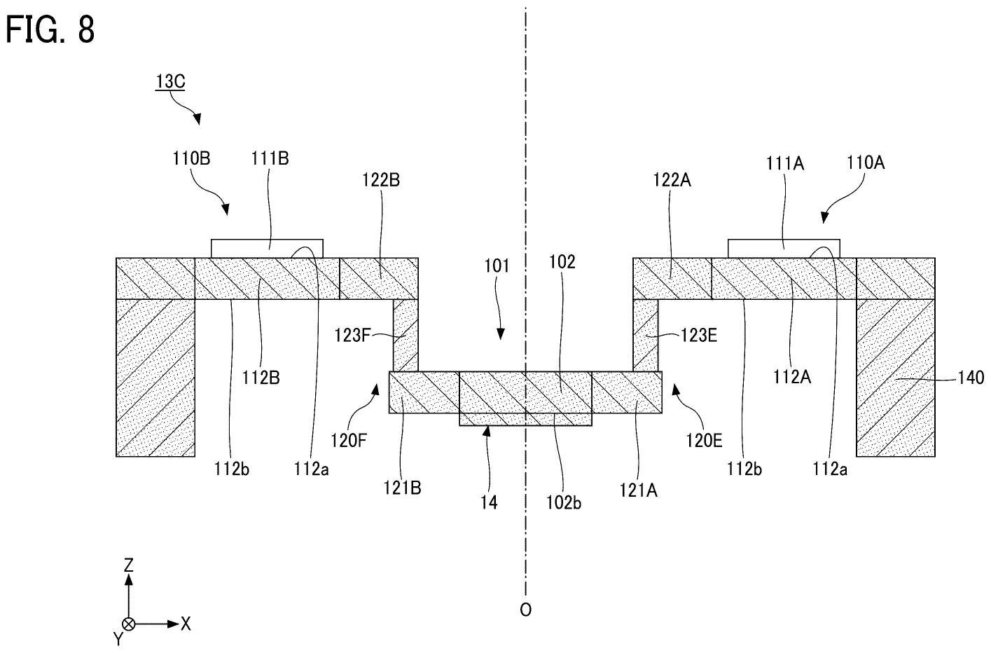

A movable device 13C according to the third embodiment will be described. FIG. 8 is a cross-sectional view of the movable device according to a third embodiment of the present disclosure. The difference between the movable device 13C according to the third embodiment and the movable device 13 according to the first embodiment is that an arrangement of the mirror 101 and the intermediate connectors 123E and 123F is different. In the following description of the third embodiment, descriptions similar to those of the first embodiment are omitted.

The mirror 101 of the movable device 13C is disposed inside the support section 140 in the Z-axis direction. The support portion 140 has a predetermined length in the Z-axis direction. For example, viewed in the Y-axis direction, the mirror 101 is disposed overlapping the support section 140. The mirror 101 is disposed opposite the piezoelectric elements 111A and 111B to the bases 112A and 112B in the Z-axis direction. The mirror 101 is disposed in the −Z direction from the lower surface 112B of the bases 112A and 112B. The mirror 101 does not extend in the +Z direction above the upper surface 112a of the bases 112A and 112B. The reflective surface 14 is formed on the surface 102b of the mirror base 102 in the −Z direction. The reflective surface 14 is formed on the surface 102b opposite the intermediate connectors 123E and 123F to the mirror base 102 in the −Z direction.

The movable device 13C includes the connectors 120E and 120F. The connector 120E connects the mirror 101 and the driver 110A. the connector 120F connects the mirror 101 and the driver 110B. Similarly, the movable device 13C includes connectors connected to the drivers 110C and 120D, respectively, which have similar structure to the connectors 120E and 120F, so the description is omitted.

The connector 120E includes a first connect beam 121A, a second connect beam 122A, and an intermediate connector 123E. The connector 120F has a first connect beam 121B, a second connect beam 122B, and an intermediate connector 123B.

The intermediate connector 123E extends in the Z-axis direction and connects the first connect beam 121A to the second connect beam 122A. The intermediate connector 123E is, for example, columnar. The columnar shape may be cylindrical or prismatic. The lower end of the intermediate connector 123E may be connected to the end of the first connect beam 121A that is farther from the mirror 101. The upper end of the intermediate connector 123E may be connected to the end of the second connect beam 122A that is farther from the base 112A. The intermediate connector 123E extends from the second connect beam 122A in the −Z direction.

The intermediate connector 123F extends in the −Z direction and connects the first connect beam 121B to the second connect beam 122B. The intermediate connection 123F is, for example, columnar. The columnar shape may be cylindrical or prismatic. The lower end of the intermediate connector 123F may be connected to the end of the first connect beam 121B that is farther from the mirror 101. The upper end of the intermediate connector 123F may be connected to the end of the second connect beam 122B that is farther from the base 112B. The intermediate connector 123F extends from the second connect beam 122B in the −Z direction.

The movable device 13C according to the third embodiment also has the same effect as the movable device 13 according to the first embodiment. The mirror 101 may be disposed in the −Z direction with respect to the drivers 110A and 110B. The intermediate connectors 123E and 123F may extend from the second connect beams 122A and 122B in the −Z direction. In the movable device 13B according to the second embodiment, the mirror 101 may be arranged in the −Z direction with respect to the drive sections 110A and 110B.

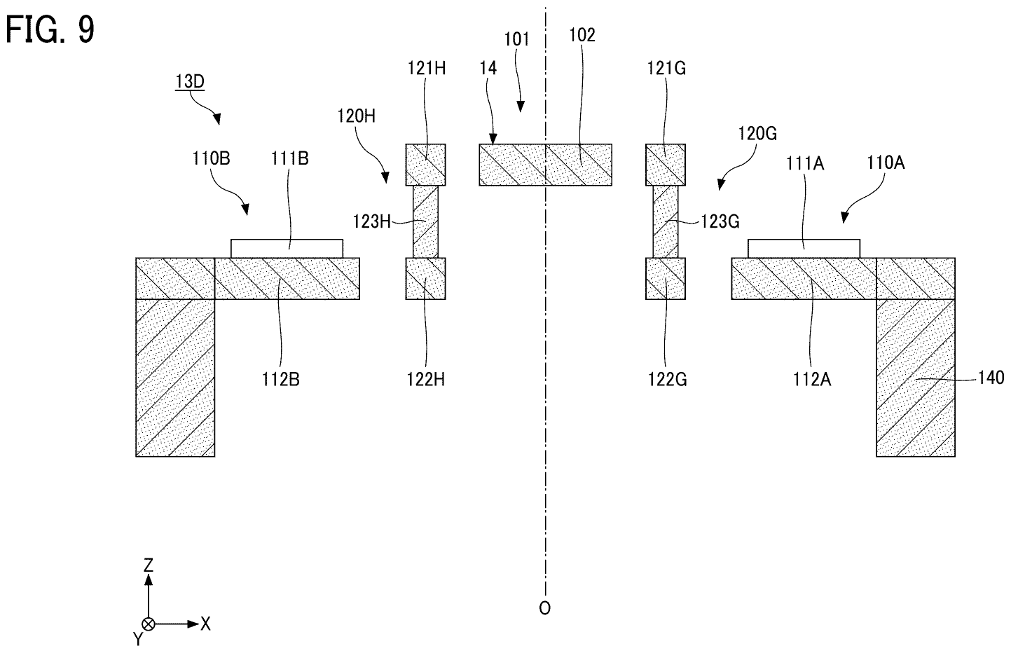

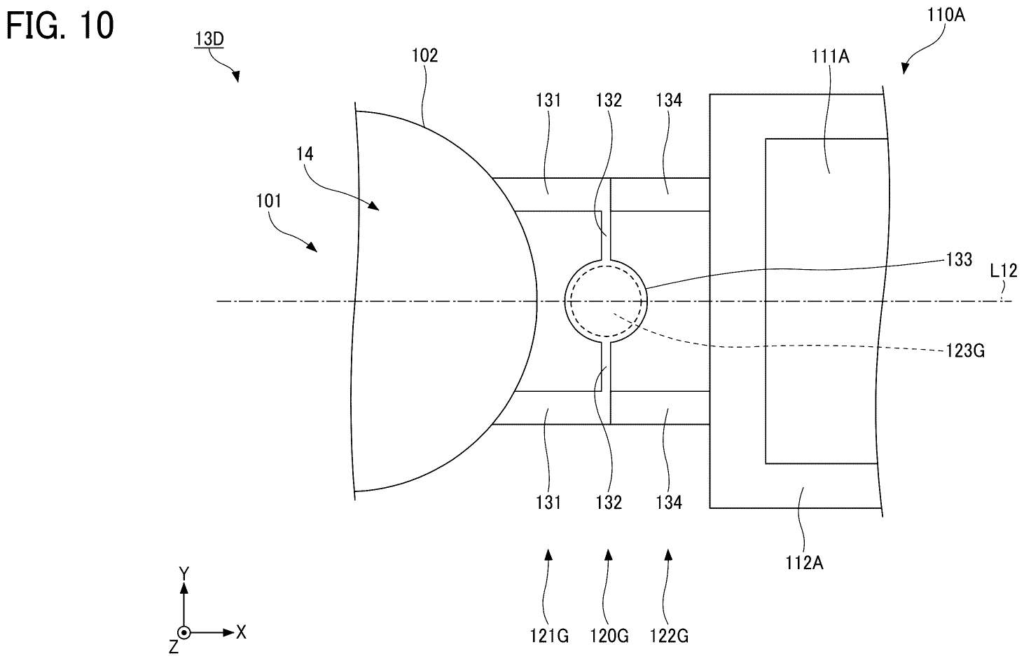

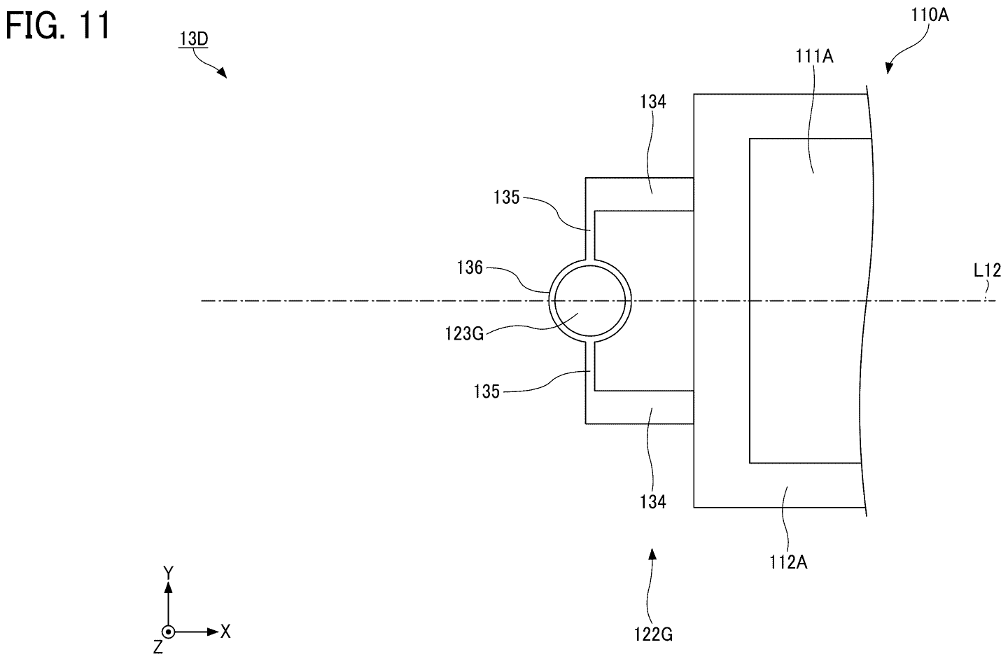

A movable device 13D according to the fourth embodiment will be described. FIG. 9 is a cross-sectional view of the movable device according to a fourth embodiment of the present disclosure, illustrating a cut plane along the second axis L12 illustrated in FIGS. 10 and 11. FIG. 10 is a plan view of the mirror, the connector, and a part of the driver. FIG. 11 is a cross-sectional view of the part of the connector and the driver. The difference between the movable device 13D according to the fourth embodiment and the movable device 13 according to the first embodiment is that the movable device 13D includes connectors 120G and 120H instead of the connectors 120A and 120B. In the following description of the fourth embodiment, explanations similar to those of the first embodiment are omitted.

The movable device 13D includes the connectors 120G and 120H, as illustrated in FIG. 9. The connector 120G connects the mirror 101 to the driver 110A. The connector 120H connects mirror 101 to the driver 110B. Similarly, the movable device 13D includes connectors connected to the drivers 110C and 110D. The connectors connected to the drivers 110C and 110D, respectively, which have similar structure to the connectors 120G and 120H, so the description is omitted.

The connector 120G includes a first connect beam 121G, a second connect beam 122G, and an intermediate connector 123G. The connector 120H includes a first connect beam 121H, a second connect beam 122H, and an intermediate connector 123H.

The first connect beam 121G has a pair of first beams 131, a pair of first support beams 132, and a first support panel 133, as illustrated in FIG. 10. The pair of first beams 131 extend in the X-axis direction and are separated in the Y-axis direction. The end of the first beams 131 closer to the mirror 101 is connected to the mirror 101.

The pair of first support beams 132 extend inwardly from each other from the pair of first beams 131. The pair of first support beams 132 extend in the Y-axis direction so as to be close to each other. The pair of first support beams 132 are connected to the end of the pair of first beams 131 that is farther from the mirror 101. The width of the first support beams 132 intersecting in the longitudinal direction is narrower than the width of the first beams 131 intersecting in the longitudinal direction.

The first support panel 133 connects with the pair of first support beams 132. The first support panel 133 is disposed between the pair of first support beams 132 in the Y-axis direction. The first support panel 133 has a disk shape. The intermediate connector 123G is connected to the first support panel 133.

The second connect beam 122G includes a pair of second beams 134, a pair of second support beams 135, and a second support panel 136, as illustrated in FIG. 11. The pair of second beams 134 extend in the X-axis direction and are separated in the Y-axis direction. The end of the second beams 134 closer to the driver 110A is connected to the driver 110A.

As illustrated in FIG. 11, the pair of second support beams 135 extend inwardly from each other from the pair of second beams 134. The pair of second support beams 135 extend in the Y-axis direction so as to be close to each other. The pair of second support beams 135 are connected to the end of the pair of second beams 134 that is farther from the driver 110A. The width of the second support beams 135 intersecting in the longitudinal direction is narrower than the width of the second beams 134 intersecting in the longitudinal direction.

The second support panel 136 connects with the pair of second support beams 135. The second support panel 136 disposed between the pair of second support beams 135 in the Y-axis direction. The second support panel 136 has a disk shape. The intermediate connector 123G is connected to the second support plate 136.

The intermediate connector 123G extends in the Z-axis direction and connects the first connect beam 121G and the second connect beam 122G. The intermediate connector 123G is, for example, columnar. The columnar shape may be a cylindrical or prismatic. The upper end of the intermediate connector 123G may be connected to the first support panel 133 of the first connect beam 121G. The lower end of the intermediate connector 123G may be connected to the second support panel 136 of the second connect beam 122G. The intermediate connection 123G extends from the second support panel 136 of the second connect beam 122G in the +Z direction.

The first connect beam 121H, the second connect beam 122H, and the intermediate connector 123H of the connector 120H have the same structure as the first connect beam 121G, the second connect beam 122G, and the intermediate connector 123G of the connector 120G, so the description is omitted.

The movable device 13D according to fourth embodiment also has the same effect as the movable device 13 according to the first embodiment. The first connect beam 121G may be configured with the pair of first beams 131 disposed apart in the Y-axis direction. The second connect beam 122G may be configured with the pair of second beams 134 disposed apart in the Y-axis direction. The movable device 13B according to the second embodiment and the movable device 13C according to the third embodiment may be configured with the pair of first beams 131 and the pair of second beams 134.

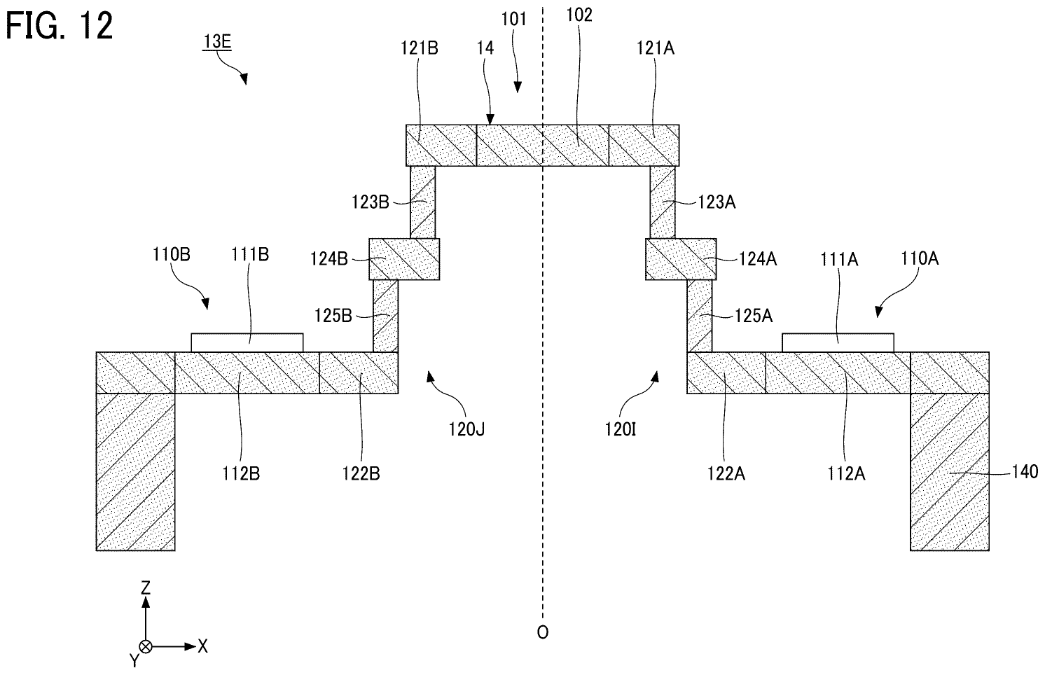

A movable device 13E according to the fifth embodiment will be described. FIG. 12 is a cross-sectional view of the movable device according to the fifth embodiment of the present disclosure. The difference between the movable device 13E according to the fifth embodiment and the movable device 13 according to the first embodiment is that the movable device 13E includes connectors 120I and 120J instead of connectors 120A and 120B. In the following description of the fifth embodiment, explanations similar to those of the first embodiment are omitted.

The movable device 13E includes the connectors 1201 and 120J, as illustrated in FIG. 12. The connector 120I connects the mirror 101 to the driver 110A. The connector 120J connects the mirror 101 to the driver 110B. Similarly, the movable device 13E includes connectors connected to the drivers 110C and 110D. The connectors connected to the drivers 110C and 110D, respectively, which have similar structure to the connectors 120I and 120J, so the description is omitted.

The connector 120I includes the first connect beam 121A, the second connect beam 122A, the intermediate connector (first intermediate connector) 123A, a third connect beam 124A, and an intermediate connector (second intermediate connector) 125A. The connector 120J includes the first connect beam 121B, the second connect beam 122B, the intermediate connector (first intermediate connector) 123B, a third connect beam 124B, and an intermediate connector (second intermediate connector) 125B. Similarly, connectors 120C and 120D include the first connect beam, the second connect beam, the intermediate connector (first intermediate connector), a third connect beam, and an intermediate connector (second intermediate connector), respectively.

The intermediate connector 123A extends in the Z-axis direction and connects the first connect beam 121A and the third connect beam 124A. The intermediate connector 123A is, for example, columnar. The columnar shape may be cylindrical or prismatic. The upper end of the intermediate connector 123A may be connected to the end of the first connect beam 121A that is farther from the mirror 101. The lower end of the intermediate connector 123A may be connected to the third connect beam 124A. The intermediate connector 123A extends from the first connect beam 121A in the −Z direction.

The third connect beam 124A extends from the lower end of the intermediate connector 123A in the X-axis direction. The third connect beam 124A extends in the X-axis direction so as to approach the drive 110A. The third connect beam 124A connects the intermediate connector 123A to the intermediate connector 125A.

The intermediate connector 125A extends in the Z-axis direction and connects the second connect beam 122A and the third connect beam 124A. The intermediate connector 125A is, for example, columnar. The columnar shape may be cylindrical or prismatic. The upper end of the intermediate connector 125A may be connected to the end of the third connect beam 124A that is farther from the intermediate connector 123A. The lower end of the intermediate connector 125A may be connected to the end of the second connect beam 122A that is farther from the driver 110A. The intermediate connector 125A extends from the second connect beam 122A in the +Z direction.

The intermediate connector 123B, the third connect beam 124B, and the intermediate connector 125B of the connector 120J have the same structure as the intermediate connector 123A, the third connect beam 124A, and the intermediate connector 125A of the connector 120I, so the description is omitted.

The movable device 13E according to the fifth embodiment also has the same effect as the movable device 13 according to the first embodiment. The movable device 13E may be configured with the third connect beams 124A and 124B, and the intermediate connectors 125A and 125B. The movable device 13B, 13C, and 13D may also be configured with the third connect beams 124A and 124B, and the intermediate connectors 125A and 125B.

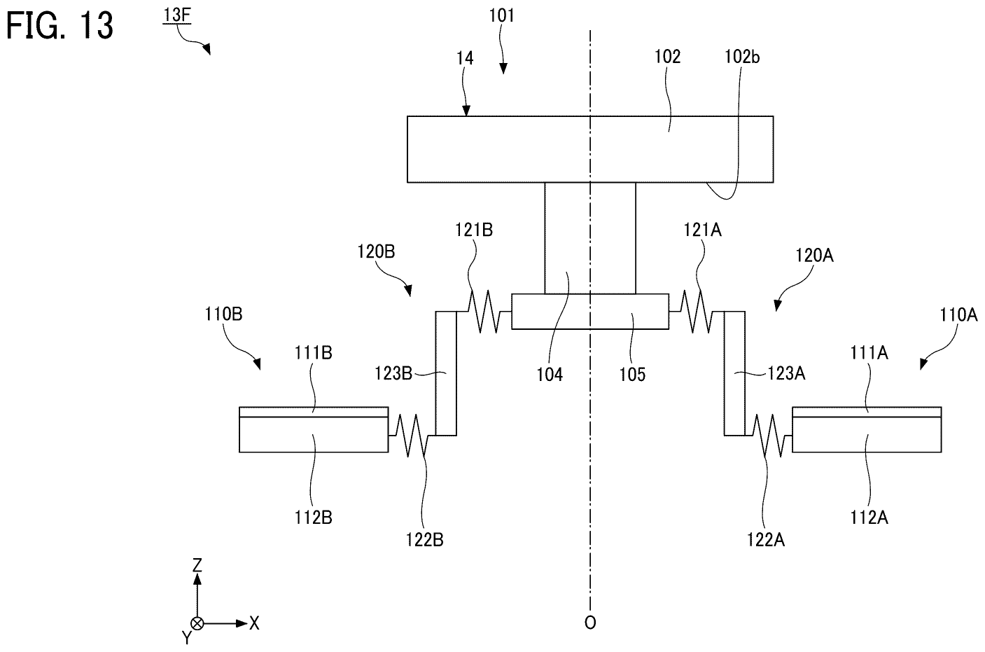

A movable device 13F according to the sixth embodiment will be described. FIG. 13 is a schematic diagram of the movable device according to the sixth embodiment of the present disclosure. The difference between the movable device 13F according to the sixth embodiment and the movable device 13 according to the first embodiment is that in the movable device 13F, on the rear side of the mirror 101 includes a rear-side overhang portion 104 and a rear-side connector 105. In the following description of the sixth embodiment, descriptions similar to those of the first embodiment are omitted.

The mirror 101 includes the mirror base (movable base) 102, the rear-side overhang portion 104, and a rear-side connector 105.

The rear-side overhang portion 104 extends from the back surface 102b, which is the opposite side of the reflective surface 14, in a direction along the center line O. The rear-side overhang portion 104 is, for example, columnar. The columnar shape may be cylindrical or prismatic. The rear-side overhang portion 104 may be other than columnar. The diameter of the rear-side overhang portion 104 may be smaller than the diameter of the reflective surface 14, for example.

The rear-side connector 105 is connected to the rear-side overhang portion 104. The rear-side connector 105 is, for example, disk-shaped. The rear-side connector 105 may be other shapes other than a disk shape. The rear-side connector 105 connects to first connect beams 121A and 121B. The first connect beam 121A and 121B may be connected to the rear-side overhang portion 104 instead of the rear-side connector 105. The diameter of the rear-side connector 105 may be smaller than the diameter of the reflective surface 14, for example.

The movable device 13F according to the sixth embodiment also has the same effect as the movable device 13 according to the first embodiment.

In addition, in the movable device 13F, the rear-side overhang portion 104 makes the reflective surface 14 project in the +Z direction. The projection of the reflective surface 14 can prevent the mirror 101 from contacting the connectors 120A and 120B, and the drivers 110A and 110B when the mirror 101 is oscillating.

In addition, in the movable device 13F, the diameter of the reflective surface 14 is larger than the diameter of the rear-side connector 105, which allows the reflective surface 14 to oscillate more efficiently. This is based on the fact that when the displacement Z1 in the Z-axis direction generated by the drivers 110A and 110B is the same, the oscillation angle θ is larger when the diameter R1 of the movable portion (rear-side connector 105) to which the connectors 120A and 120B are directly connected is smaller than when the diameter R1 is larger (see formula (1) below) (θ=sin−1)

(θ=sin−1(Z1/R1)) (1)

In the movable device 13F, the rear-side overhang portion 104 and the rear-side connector 105 may be formed separately or integrally. The movable device 13F may be provided with the rear-side overhang portion 104 and without the rear-side connector 105. The connectors 120A and 120B may be connected to the rear-side overhang portion 104.

Embodiments of various applications to which the movable device 13, 13B, 13C, 13D, 13E, or 13F according to embodiments of the present disclosure is applied will be described below.

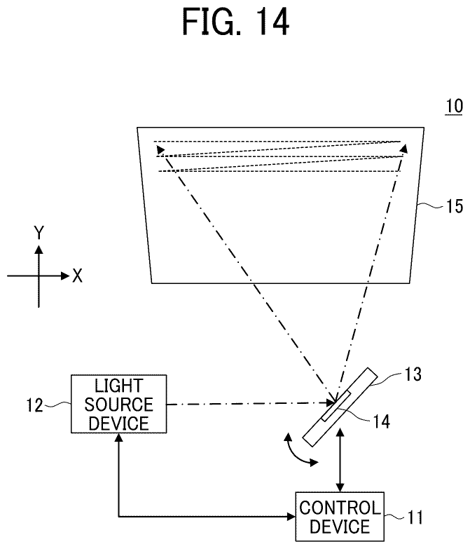

First, a light scan system 10 to which the movable device 13 according to an embodiment of the present disclosure is applied will be described in detail with reference to FIGS. 14 to 17. FIG. 14 is a schematic diagram illustrating an example of the light scan system 10. As illustrated in FIG. 14, the light scan system 10 deflects the light beam emitted from a light source device 12 by the mirror surface 14 of the movable device 13 under the control of a control device 11, and optically scans a scan surface 15 with the light beam.

The light scan system 10 includes the control device 11, the light source device 12, and the movable device 13 having the mirror surface 14.

The control device 11 is an electronic circuit unit including, for example, a central processing unit (CPU) and a field-programmable gate array (FPGA). The movable device 13 is, for example, a micro electromechanical systems (MEMS) device having a mirror surface 14 and can move the mirror surface 14. The light source device 12 is, for example, a laser device to emit a laser beam. The scan surface 15 is, for example, a screen.

The control device 11 generates a control command for the light source device 12 and the movable device 13 based on the obtained optical scan information, and outputs a drive signal to the light source device 12 and the movable device 13 based on the control command.

The light source device 12 irradiates an object with a light beam based on the input drive signal. The movable device 13 moves the mirror surface 14 in at least one of one-axial direction or two-axial directions based on the input drive signal.

Accordingly, for example, the mirror surface 14 of the movable device 13 is reciprocated in two-axial directions within a predetermined range by the control device 11 based on image information as an example of optical scan information so that the irradiation light beam from the light source device 12 that goes in the mirror surface 14 is deflected around a certain axis to perform optical scan. As a result, any image is projected onto the scan surface 15.

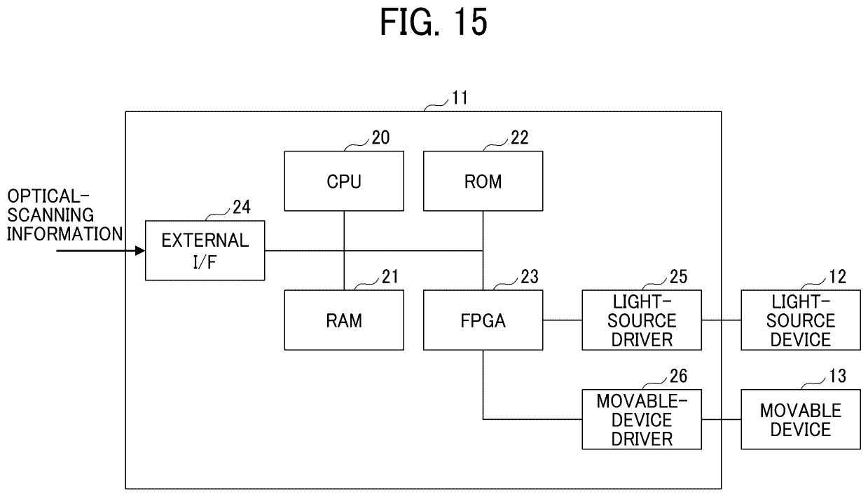

A hardware configuration of an example of the light scan system 10 will be described with reference to FIG. 15. FIG. 15 is a diagram illustrating a hardware configuration of a light scan system 10. As illustrated in FIG. 15, the light scan system 10 includes a control device 11, a light source device 12, and a movable device 13, which are electrically connected. The control device 11 includes a CPU 20, a random-access memory (RAM) 21, a read-only memory (ROM) 22, an FPGA 23, an external input and output (I/F) 24, a light source driver 25, and a movable device driver 26.

The CPU 20 is a computing device that reads programs and data from a storage device such as the ROM 22 to the RAM 21 and executes processing to implement the overall control and functions of the control device 11. The RAM 21 is a volatile storage device to temporarily hold programs and data. The ROM 22 is a nonvolatile storage device that can retain programs and data even when the power is turned off, and stores processing programs and data executed by the CPU 20 to control the functions of the light scan system 10. The FPGA 23 is a circuit that outputs control signals suitable for the light source driver 25 and the movable device driver 26 in accordance with the processing of the CPU 20.

The external I/F 24 is, for example, an interface with an external device or a network. Examples of the external device include a host device such as a personal computer (PC), and a storage device such as a universal serial bus (USB) memory, an SD card, a compact disk (CD), a digital versatile disk (DVD), a hard disk drive (HDD), or a solid-state drive (SSD). The network is, for example, a controller area network (CAN) for an automobile, a local area network (LAN), and the Internet. The external I/F 24 may enable connection or communication with the external device, and the external I/F 24 may be prepared for each external device.

The light source driver is an electric circuit that outputs a drive signal such as a drive voltage to the light source device 12 in accordance with an input control signal. The movable device driver 26 is an electric circuit that outputs a drive signal such as a drive voltage to the movable device 13 in accordance with an input control signal. In the control device 11, the CPU 20 acquires optical scan information from an external device or a network via the external I/F 24. Any configuration is acceptable as long as the CPU 20 can acquire the optical scan information, and the optical scan information may be stored in the ROM 22 or the FPGA 23 in the control device 11. Alternatively, for example, a storage device such as an SSD may be additionally disposed in the control device 11 and the optical scan information may be stored in the storage device.

The optical scan information is information indicating how the scan surface 15 is optically scanned, and for example, when an image is displayed by optical scan, the optical scan information is image data. In addition, for example, when optical writing is performed by optical scan, the optical scan information is writing data indicating a writing order and a writing position. Further, for example, when an object is recognized by optical scan, the optical scan information includes irradiation data indicating the irradiation timing and an irradiation range with a light beam for object recognition.

The control device 11 can implement a functional configuration described below by an instruction of the CPU 20 and the hardware configuration illustrated in FIG. 15.

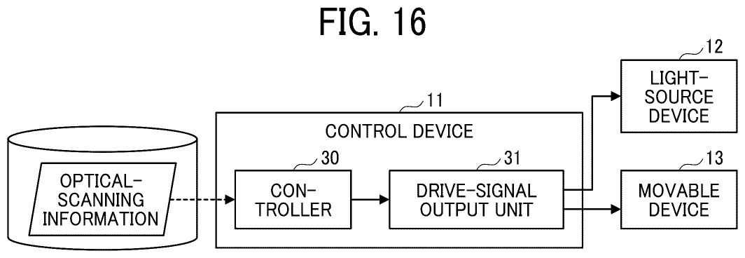

The functional configuration of the control device 11 of the light scan system 10 will be described with reference to FIG. 16. FIG. 16 is a functional block diagram illustrating an example of a control device of the light scan system. As illustrated in FIG. 16, the control device 11 includes a control unit 30 and a drive signal output unit 31 as functions.

The control unit 30 is implemented by, for example, the CPU 20 or the FPGA 23, obtains the optical scan information from an external device, converts the optical scan information into a control signal, and outputs the control signal to the drive signal output unit 31. For example, the control unit 30 obtains image data as optical scan information from, for example, an external device, generates a control signal from the image data by predetermined processing, and outputs the control signal to the drive signal output unit 31. The drive signal output unit 31 is implemented by the light source driver 25 and the movable device driver 26, and outputs a drive signal to the light source device 12 or the movable device 13 based on the input control signal.

The drive signal is a signal for controlling the drive of the light source device 12 or the movable device 13. For example, in the light source device 12, the drive voltage is used to control the irradiation timing and the irradiation intensity of the light source. In addition, for example, in the movable device 13, the drive voltage is a drive voltage for controlling the timing and the movable range of the mirror surface 14 of the movable device 13.

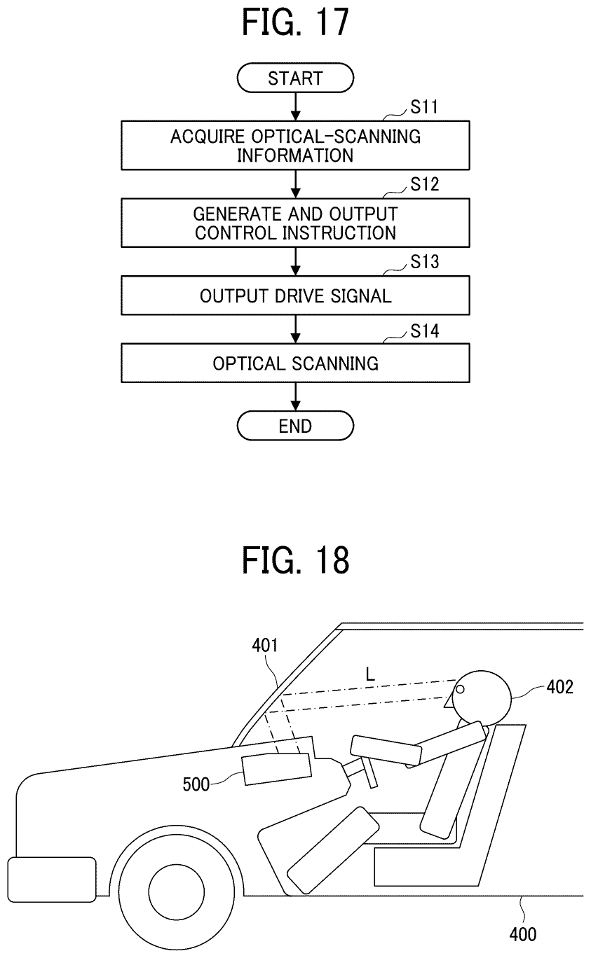

The process in which the light scan system 10 optically scans the scan surface 15 with a light beam will be described with reference to FIG. 17. FIG. 17 is a flowchart of an example of a process related to an optical scanner.

In step S11, the control unit 30 obtains optical scan information from an external device. In step S12, the control unit 30 generates a control signal from the obtained optical scan information and outputs the control signal to the drive signal output unit 31. In step S13, the drive signal output unit 31 outputs a drive signal to the light source device 12 and the movable device 13 based on the input control signal.

In step S14, the light source device 12 performs light irradiation based on the input drive signal. The movable device 13 moves the mirror surface 14 based on the input drive signal. The light source device 12 and the movable device 13 are driven so that the light beam is deflected in any direction, and optically scan is performed.

In the light scan system 10 described above, a single control device 11 includes a device and a function of controlling the light source device 12 and the movable device 13, but the device and the function may be disposed separately from the control device for the light source device and the control device for the movable device.

In the light scan system 10, the functions of the control unit 30 of the light source device 12 and the movable device 13 and the function of the drive signal output unit 31 are disposed in one control device 11, but these functions may be disposed separately. For example, a drive signal output device including the drive signal output unit 31 is disposed separately from the control device 11 including the control unit 30. The light scan system 10 described above may include an optical deflection system to perform light deflection by the movable device 13 having the mirror surface 14, and the single control device 11.

The light scan system 10 includes the movable device 13 that can obtain a large displacement amount while increasing the displacement stability. As a result, the light scan system 10 can scan a wide range with a light beam with high accuracy.

### Image Projection Apparatus

An image projection apparatus including the movable device according to the present embodiment will be described in detail with reference to FIGS. 18-23.

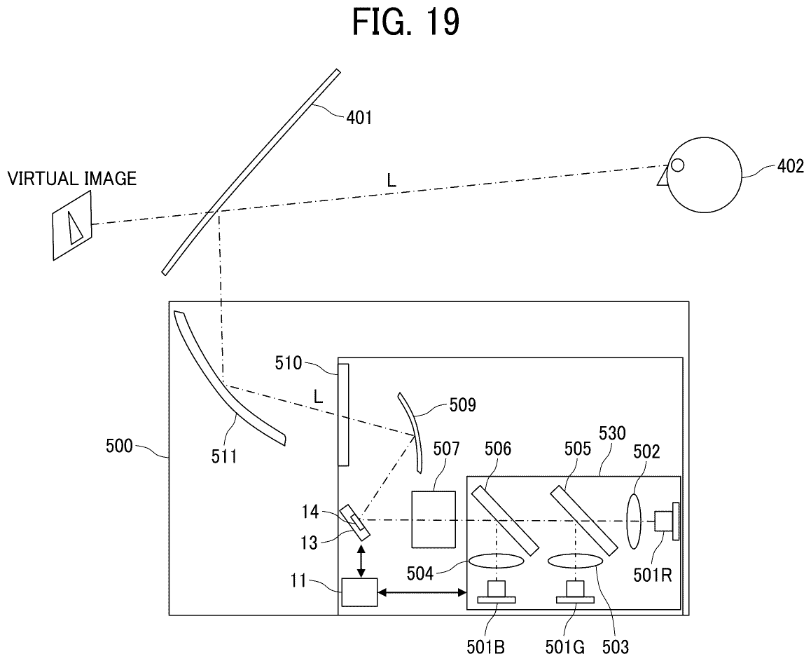

FIG. 18 is a schematic view of an automobile 400 including a head-up display device 500 as an example of an image projection apparatus. FIG. 19 is a schematic diagram illustrating an example of a head-up display device 500.

The image projection apparatus is an apparatus that projects an image by optical scan, and is, for example, a head-up display device.

As illustrated in FIG. 18, the head-up display device 500 is installed, for example, near a windshield (e.g., a front window 401) of an automobile 400. The projection light beam L emitted from the head-up display device 500 is reflected by the front window 401 and directed to an observer (e.g., a driver 402) that is a user. Accordingly, the driver 402 can visually recognize the image projected by the head-up display device 500 as a virtual image. A combiner may be disposed on an inner wall surface of the windshield, and the user may visually recognize a virtual image by the projected light beam reflected by the combiner.

As illustrated in FIG. 19, in the head-up display device 500, a red laser light source 501R emits a red laser beam, a green laser light source 501G emits a green laser beam, and a blue laser light source 501B emits a blue laser beam. These three emitted laser beams pass through an incident optical system, and are deflected by a movable device 13 including a mirror surface 14. The incident optical system includes a collimator lens 502, a collimator lens 503, and a collimator lens 504, which are disposed for the red laser beam, the green laser beam, and the blue laser beam, respectively, two dichroic mirrors 505 and 506, and a light amount adjusting unit 507. The deflected laser beams are projected onto a screen through a projection optical system including a free-form surface mirror 509, an intermediate screen 510, and a projection mirror 511. In the head-up display device 500, the red laser light source 501R, the green laser light source 501G, and the blue laser light source 501B, the collimator lens 502, the collimator lens 503, the collimator lens 504, the dichroic mirror 505, and the dichroic mirror 506 are formed as a light source unit 530 by an optical housing.

The head-up display device 500 described above projects an intermediate image displayed on the intermediate screen 510 on the front window 401 of the automobile 400 so that the driver 402 can be visually recognized the intermediate image as a virtual image.

The red laser beam emitted from the red laser light source 501R, the green laser beam emitted from the green laser light source 501G, and the blue laser beam emitted from the blue laser light source 501B are collimated by the collimator lens 502, the collimator lens 503, and the collimator lens 504, respectively, as substantially parallel laser beams, and are combined by the two dichroic mirrors 505 and 506. The amount of the combined laser beam is adjusted by the light amount adjusting unit 507, and the movable device 13 including the mirror surface 14 two-dimensionally scans the free-form surface mirror 509 with the laser beam. The projection light beam L with which the movable device 13 two-dimensionally scans the free-form surface mirror 509 is reflected by the free-form surface mirror 509 is corrected in distortion, and is condensed on the intermediate screen 510 to display an intermediate image. The intermediate screen 510 includes a microlens array in which microlenses are two-dimensionally arranged, and enlarges the projection light beam L incident on the intermediate screen 510 at each microlens.

The movable device 13 reciprocates the mirror surface 14 in two-axial directions and two-dimensionally scans the free-form surface mirror 509 with the projection light beam. The control of the movable device 13 is performed in synchronism with the timing of light emission of the red laser light source 501R, the green laser light source 501G, and the blue laser light source 501B.

As described above, the head-up display device 500 has been described as an example of the image projection apparatus, but the image projection apparatus may be any device that projects an image by performing optical scan with the movable device 13 including the mirror surface 14. For example, the image projection apparatus can be applied to a projector that is placed on a desk and projects an image on a display screen, and a head-mounted display device that projects an image to a reflective-and-transmissive screen included in a mounting member mounted on an observer's head or projects an image to an eyeball as a screen.

The image projection apparatus may be included in not only a vehicle and a mounting member but also, for example, a moving body such as an aircraft, a ship, and a mobile robot, or a non-moving body such as a work robot that operates a drive object such as a manipulator without moving from the site.

The head-up display device 500 is an example of a head-up display. The automobile 400 is an example of a vehicle.

Since the head-up display device 500 includes the movable device 13 that can obtain a large displacement amount while increasing the displacement stability, a large screen image with high image quality can be displayed.

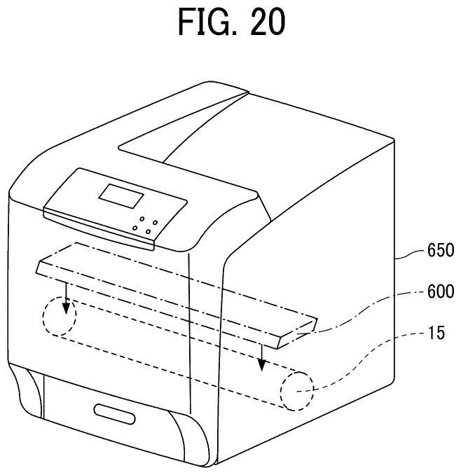

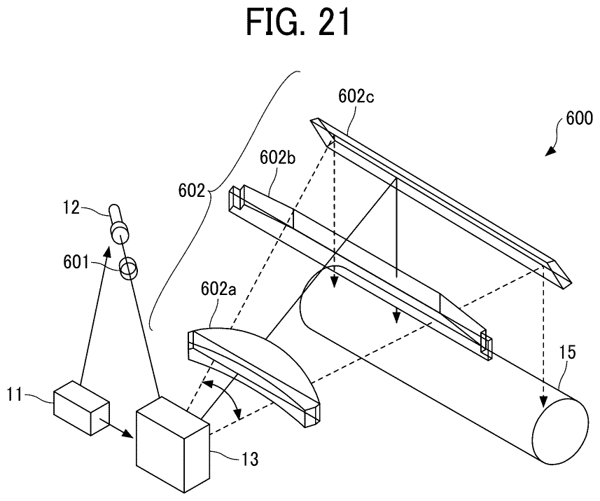

An optical writing apparatus to which the movable device 13 of the present embodiment is applied will be described in detail with reference to FIGS. 20 and 21.

FIG. 21 is a schematic diagram illustrating an example of an image forming apparatus including an optical writing apparatus 600. FIG. 21 is a schematic diagram illustrating an example of the optical writing apparatus 600.

As illustrated in FIG. 21, the optical writing apparatus 600 is used as a unit of an image forming apparatus such as a laser printer 650 having a printer function using a laser beam. In the image forming apparatus, the optical writing apparatus 600 optically scans a photoconductive drum that serves as a scan surface 15 with one or multiple laser beams, to perform optical writing to the photoconductive drum.

As illustrated in FIG. 21, in the optical writing apparatus 600, a laser beam from a light source device 12 such as a laser element passes through an imaging optical system 601 such as a collimator lens, and is deflected in one-axial direction or two-axial directions by a movable device 13 including a mirror surface 14. The laser beam deflected by the movable device 13 passes through the scanning optical system 602 including a first lens 602a, a second lens 602b, and a reflecting mirror portion 602c, and the optical writing apparatus 600 irradiates the scan surface 15 (e.g., photoconductive drum or photosensitive paper) with the laser beam to perform optical writing. The scanning optical system 602 forms an image of a light beam in a spot shape on the scan surface 15. The light source device 12 and the movable device 13 including the mirror surface 14 are driven based on the control of the control device 11.

As described above, the optical writing apparatus 600 can be used as a member of an image forming apparatus having a printer function by a laser beam. Further, the optical writing apparatus 600 can change the scanning optical system to perform optical scan not only in one-axial direction but also two-axial directions, and thus can be used as a unit of the image forming apparatus such as a laser label apparatus that deflects the laser beam to a thermal medium to print by heating.

Since the movable device 13 including the mirror surface 14 applied to the optical writing apparatus has a smaller power consumption for driving than a rotary polygon mirror using a polygon mirror, and the movable device 13 has an advantage in saving power of the optical writing apparatus. In addition, since the wind noise generated when the movable device 13 is vibrated is smaller than the wind noise of the rotary polygon mirror, it is advantageous for increasing the quietness of the optical writing apparatus. The optical writing apparatus requires a much smaller installation space than the rotary polygon mirror, and the movable device 13 generates a small amount of heat, so that the optical writing apparatus can be easily reduced in size. As a result, the image forming apparatus has an advantage in reducing in size.

Since the optical writing apparatus 600 includes the movable device 13 that can obtain a large displacement amount while increasing the displacement stability, an image with high image quality can be formed on a large region of a recording medium.

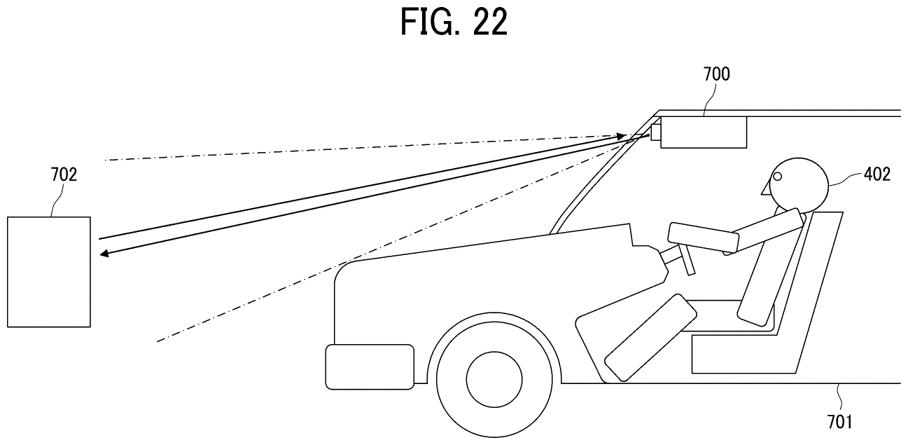

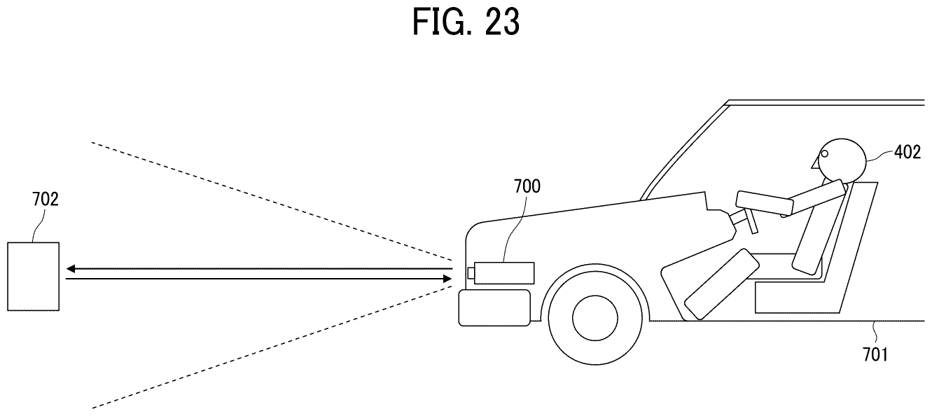

An object recognition apparatus to which the movable device of the present embodiment is applied will be described in detail with reference to FIGS. 22 and 23.

FIG. 22 is a schematic diagram illustrating an automobile in which a laser imaging detection and ranging (LiDAR) apparatus that is an example of an object recognition apparatus is mounted. In the schematic diagram, the LiDAR apparatus is mounted on a body of the automobile.

FIG. 23 is a schematic diagram illustrating an automobile in which a laser imaging detection and ranging (LiDAR) apparatus that is an example of an object recognition apparatus is mounted. In the schematic diagram, the LiDAR apparatus is mounted on a lighting unit including a headlight of the automobile.

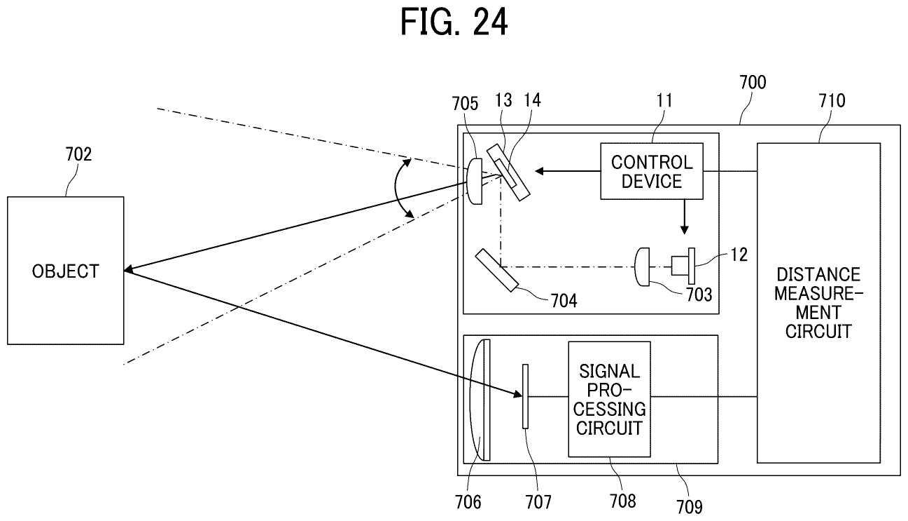

FIG. 24 is a schematic diagram illustrating an example of a LiDAR apparatus. The object recognition apparatus is an apparatus that recognizes an object in a target direction, and is, for example, a LiDAR apparatus. As illustrated in FIGS. 22 and 23, the LiDAR apparatus 700 is mounted on, for example, an automobile 701, and scans a region with a light beam in a predetermined direction, and recognizes the object 702 in the region by receiving the reflected light beam from the object 702.

As illustrated in FIG. 24, the movable device 13 includes an incident optical system including a collimate lens 703 that is an optical system to form a divergent light beam into a substantially parallel light beam, and a plane mirror 704. The movable device 13 including the mirror surface 14 scans an object with the laser beam that is emitted from the light source device 12 and passes through the incident optical system in a one-axial direction or two-axial directions. The substantially parallel light deflected by the movable device 13 reaches the object 702 in front of the LiDAR apparatus 700 via a projection lens 705 that is a projection optical system. The control device 11 drives the light source device 12 and the movable device 13. The light detector 709 detects the reflected light beam reflected by the object 702. In other words, the reflected light beam passes through a condenser lens 706 that is an optical system for receiving and detecting the incident light beam, and is received by an image sensor 707. The image sensor 707 outputs a detected signal to a signal processing circuit 708. The signal processing circuit 708 performs predetermined processing such as binarization or noise processing on the received detection signal, and outputs the result to a distance measurement circuit 710.

The distance measurement circuit 710 determines the presence or absence of the object 702 according to a time difference between a timing at which the light source device 12 emits the laser beam and a timing at which the light detector 709 receives the laser beam, or a phase difference for each pixel of the image sensor 707 that receives the laser beam, and calculates distance information with respect to the object 702.

Since the movable device 13 including the mirror surface 14 is less likely to be damaged as compared with a polygon mirror and is smaller in size, a smaller LiDAR apparatus having higher durability can be provided. When the LiDAR apparatus is attached to, for example, a vehicle, an aircraft, a ship, or a robot, the presence or absence of an obstacle or an object can be determined or the distance to the obstacle or the object can be recognized by performing optical scan within a predetermined range.

In the object recognition apparatus described above, the LiDAR apparatus 700 is described as an example. However, the object recognition apparatus is not limited to the embodiment described above as long as the object recognition apparatus performs optical scan by the movable device 13 including the mirror surface 14 under control of the control device 11 and receives the reflection light beam by the light detector to recognize the object 702.

The object recognition apparatus described above can be applied to, for example, a biometric authentication apparatus that calculates object information such as a shape from the distance information obtained by scanning a hand or a face and recognizes the object by referring the record, a security sensor that recognizes an intruder by optically scanning the object region, or a unit of the three-dimensional scanner that outputs three-dimensional data.

Since the object recognition apparatus includes the movable device 13 that can obtain a large displacement amount while increasing the displacement stability, the object recognition apparatus can recognize an object in a wide range with high accuracy.

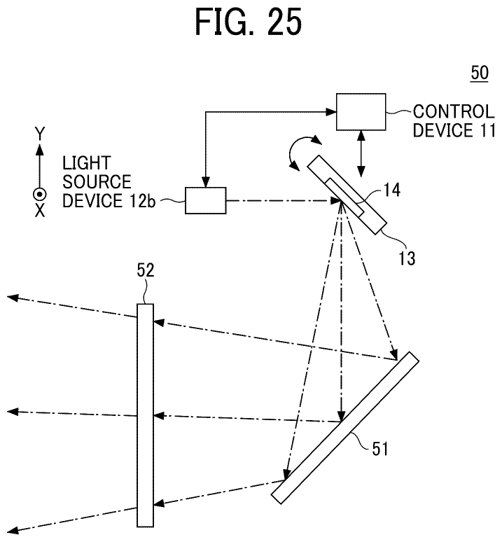

A laser headlamp 50 in which the movable device of the present embodiment is applied to a headlight of an automobile will be described with reference to FIG. 25. FIG. 25 is a schematic diagram illustrating an example of a configuration of the laser headlamp 50.

The laser headlamp 50 includes a control device 11, a light source device 12b, a movable device 13 including a mirror surface 14, a mirror 51, and a transparent plate 52.

The light source device 12b is a light source that emits a blue laser beam. The light beam emitted from the light source device 12b goes in the movable device 13 and is reflected by the mirror surface 14. The movable device 13 moves the mirror surface in the X- and Y-directions based on the signal from the control device 11, and two-dimensionally scans an object with the blue laser beam from the light source device 12b in the X- and Y-directions.

The scan light beam by the movable device 13 is reflected by the mirror 51 and goes in the transparent plate 52. The front surface or the back surface of the transparent plate 52 is coated with a yellow fluorescent material. The blue laser beam from the mirror 51 changes to white in the legalized range of the color of the headlight when passing through the yellow phosphor coating of the transparent plate 52. Thus, the area ahead of the automobile is illuminated with the white light beam from the transparent plate 52.

The scan light beam by the movable device 13 is scattered in a predetermined manner when passing through the fluorescent material of the transparent plate 52. Accordingly, the glare of the illumination object ahead of the automobile is reduced.

When the movable device 13 is applied to a headlight of an automobile, the colors of the light source device 12b and the fluorescent material are not limited to blue and yellow, respectively. For example, the light source device 12b may be a near-ultraviolet light source, and the transparent plate 52 may be coated with a mixture of uniformly mixed phosphors of blue, green, and red, which are the three primary colors of light. In this case, the light beam passing through the transparent plate 52 can be converted into white light, and the area ahead of the automobile can be illuminated with white light beam.

Since the laser headlamp 50 includes the movable device 13 that can obtain a large displacement amount while increasing the displacement stability, the laser headlamp can irradiate a wide region with a laser beam with high accuracy.

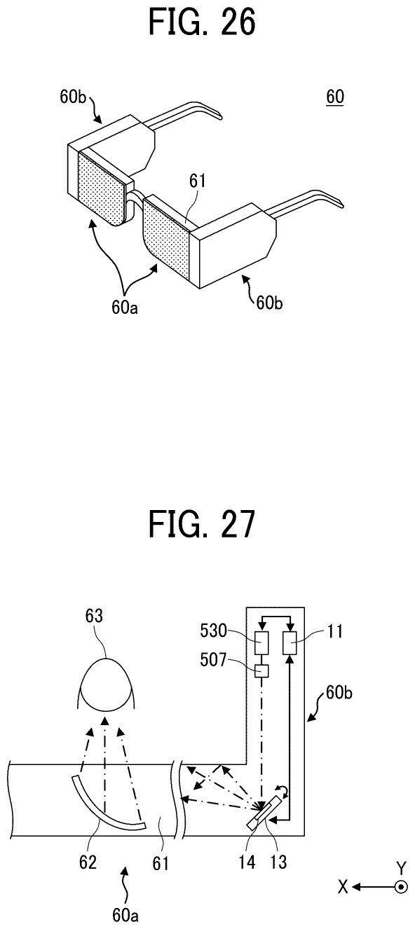

A head-mounted display (HMD) 60 to which the movable device of the present embodiment is applied will be described with reference to FIGS. 25 and 26. The HMD 60 is a head-mounted display that can be mounted on the human head, and has a shape of, for example, glasses.

FIG. 26 is a perspective view of an external appearance of the HMD 60. In FIG. 26, the HMD 60 includes fronts 60a symmetrically disposed in a pair on the left and right sides and temples 60b. The fronts 60a can be formed by, for example, light guide plates 61, and an optical system and a control device can be built in the temples 60b.

FIG. 27 is a diagram illustrating a partial configuration of the HMD 60. Although FIG. 27 illustrates the partial configuration for the left eye, the HMD 60 has the same configuration for the right eye.

The HMD 60 includes a control device 11, a light source unit 530, a light amount adjusting unit 507, a movable device 13 including a mirror surface 14, a light guide plate 61, and a half mirror 62.

As described above, the light source unit 530 includes the red laser light source 501R, the green laser light source 501G, the blue laser light source 501B, the collimator lens 502, the collimator lens 503, the collimator lens 504, the dichroic mirror 505, and the dichroic mirror 506 in an optical housing as a unit. In the light source unit 530, the red laser beam from the red laser light source 501R, the green laser beam from the green laser light source 501G, and the blue laser beam from the blue laser light source 501B are combined by the dichroic mirror 505 and the dichroic mirror 506. The light source unit 530 emits the combined parallel light beam.

The light beam from the light source unit 530 is adjusted by the light amount adjusting unit 507 in its light amount and goes in the movable device 13. The movable device 13 moves the mirror surface 14 in the X- and Y-directions based on the signal from the control device 11, and two-dimensionally scans an object with the laser beam from the light source unit 530. The control of the movable device 13 is performed in synchronism with the timing of light emission of the red laser light source 501R, the green laser light source 501G, and the blue laser light source 501B, and a color image is formed by optical scan.

The scan light beam by the movable device 13 goes in the light guide plate 61. The light guide plate 61 guides the scan light beam to the half mirror 62 while reflecting the scan light beam on the inner wall surfaces. The light guide plate 61 is made of a resin having a transparency with respect to the wavelength of the scan light beam.

The half mirror 62 reflects the light beam from the light guide plate 61 to the back surface side of the HMD 60 and emits the light beam in the direction of the eye of a wearer 63 of the HMD 60. The half mirror 62 has, for example, a free-form surface shape. The image by the scan light beam is reflected by the half mirror 62, and is imaged on the retina of the wearer 63. Alternatively, the image is formed on the retina of the wearer 63 by reflection at the half mirror 62 and the lens effect of the lens of the eyeball. The spatial distortion of the image is corrected by the reflection at the half mirror 62. The wearer 63 can observe the image formed with the light beam scanned in the X- and Y-directions.

Since the half mirror 62 is used, the wearer 63 observes a superimposed image of an image of a light beam from the outside and an image by scan light beam. A mirror may be used instead of the half mirror 62 so that the light beam from the outside is eliminated, and only an image by the scan light beam can be observed.

Since the HMD 60 includes the movable device 13 that can obtain a large displacement amount while increasing the displacement stability, the HMD 60 can display a large screen image with high image quality.

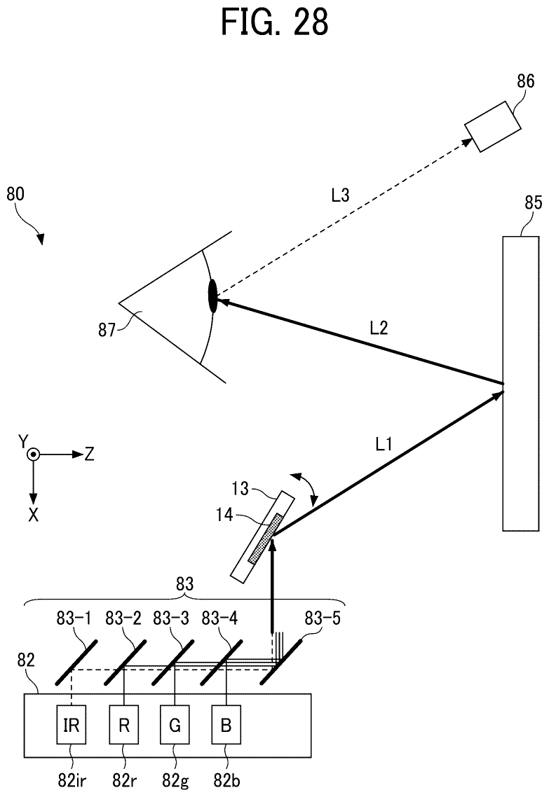

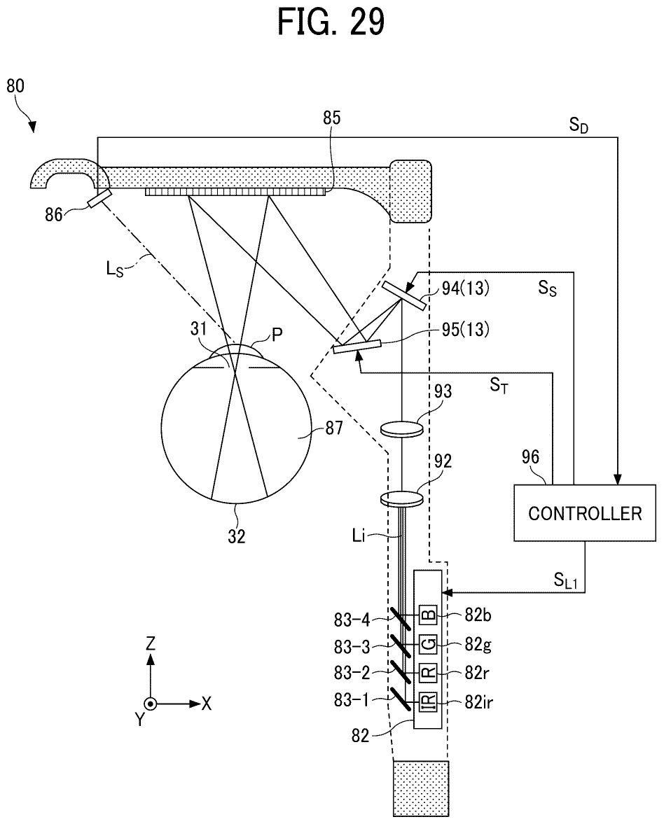

A tilt-position detection apparatus of an eyeball that includes the movable device 13 will be below. The tilt-position detection apparatus for the eyeball is a pupil-or-cornea position detection apparatus 80. FIG. 28 is a schematic block diagram illustrating an example of a pupil-or-cornea position detection apparatus 80. FIG. 29 is a schematic block diagram illustrating an example of the pupil-or-cornea position detection apparatus 80 mounted on a head-mounted display.

The “tilt-position of the eyeball” in the present embodiment is the position of the pupil-or-cornea of the eyeball or the direction of the user's line of sight. In the following description, the “tilt-position of the eyeball” is the position of the pupil or the cornea, and the “tilt-position detection apparatus of the eyeball” is the “pupil-or-cornea position detection apparatus.” The pupil-or-cornea position detection apparatus described below is the same as a line-of-sight direction tracking apparatus (eye tracking apparatus) that detects or tracks the direction of the user's line of sight continuously or at intervals of time.

The pupil-or-cornea position detection apparatus 80 illustrated in FIG. 28 includes a light source 82, a first light deflection part 83, a movable device 13, a second light deflection part 85, and a light receiving unit 86.

The light source 82 includes, for example, a red laser light source 82r to emit a red laser beam, a green laser light source 82g to emit a green laser beam, a blue laser light source 82b to a blue laser light beam, and an infrared laser light source 82ir to emit an infrared laser beam. The red laser light sources 82r, the green laser light source 82g, and the blue laser light source 82b may be any one or a combination of two. The red laser light sources 82r, the green laser light source 82g, and the blue laser light source 82b emit laser beams to form an image by the movable device 13.

The infrared laser light source 82ir emits a light beam to detect the position of the pupil or the cornea. The light beam for detecting the position of the pupil or the cornea is not limited to an infrared light beam, and may be a visible light beam. The light beam for detecting the position of the pupil or the cornea is preferably an invisible light beam from the viewpoint of increasing the visibility of a drawn image.

The first light deflection part 83 is, for example, a dichroic mirror, and deflects the light beam emitted from the light source 82 toward the mirror surface 14 of the movable device 13 while combining the light beams. The pupil-or-cornea position detection apparatus 80 may include multiple first light deflection parts 83-1, 83-2, 83-3, 83-4, and 83-5, in accordance with the number of the laser light sources (i.e., the red laser light sources 82r, the green laser light source 82g, the blue laser light source 82b, and the infrared laser light source 82ir). The first light deflection part 83 includes multiple first light deflection parts 83-1, 83-2, 83-3, 83-4, and 83-5. The multiple first light deflection parts 83-1, 83-2, 83-3, 83-4, and 83-5 deflect the light beams while combining the light beams.

The movable device 13 includes a mirror surface 14 and scans the second light deflection part 85 with the light beam deflected by the first light deflection part 83 in two-dimensional directions. At this time, the movable device 13 scans the second light deflection part 85 with the light beam deflected by the first light deflection part 83 using, for example, raster scan to form an image. The movable device 13 can scan the second light deflection part 85 with the light beam deflected by the first light deflecting part 83 by spiral scan.

The second light deflection part 85 is, for example, a holographic optical element, and deflects the light beam L1 with which the movable device 13 scanned toward the eyeball 87 of the user. At least a portion of the light beam L2 deflected by the second light deflection part 85 goes in the eyeball 87 of the user as display image light beam. The second light deflection part 85 may include multiple light deflection members. For example, multiple light deflection parts that reflect specific light beams among the light beams emitted from the light source 82 may be used, and the mirror surface may be different for each light beams emitted from the light source 82. As a specific example, a structure in which a light deflection part that reflects light beams emitted from the red laser light source 82r, the green laser light source 82g, and the blue laser light source 82b and a light deflection member for reflecting the light beam emitted from the infrared laser light source 82ir are laminated in order of proximity to the eyeball 87 can be used.

The light receiving unit 86 receives the light beam L3 reflected by the eyeball 87 of the user among the light beam L2 deflected by the second light deflection part 85, and outputs a detection signal SD corresponding to the received light beam. The light receiving unit 86 is an image sensor that can detect, for example, an infrared light beam. The light receiving unit 86 may include multiple light receiving units and be disposed at positions that can receive the light beam L3 reflected by the eyeball 87 of the user. The light beam received by the light receiving unit 86 changes in intensity depending on the change in position of the eyeball (e.g., pupil or cornea), that is, the change in the direction of the line of sight. Thus, the pupil-or-cornea position detection apparatus 80 of the pupil or the cornea in the present embodiment detects or estimates the position of the pupil or the cornea based on the intensity of the light beam received by the light receiving unit 86. The light receiving unit 86 may be configured to image the eyeball 87 irradiated with the light beam L2 deflected by the second light deflection part 85. In this case, the pupil-or-cornea position detection apparatus 80 detects or estimates the tilt-position of the eyeball 87 based on the position of the pupil or cornea included in the captured image (i.e., detection signal SD) and the position at which the light beam L2 deflected by the second light deflection part 85 is reflected in the eyeball 87.

As described above, the pupil-or-cornea position detection apparatus 80 according to the present embodiment can detect the position of the pupil or cornea while forming an image by the movable device 13. Further, since the movable device 13 has a configuration that can perform optical scan more efficiently, image formation and detection of the position of the pupil or cornea can be implemented with lower power. Further, the movable device 13 can obtain the above-described effect without changing the area necessary for mounting the pupil-or-cornea position detection apparatus 80 as compared with the configuration in the related art. Accordingly, a configuration in which the size of the pupil-or-cornea position detection apparatus 80 is not increased can be implemented.

The pupil-or-cornea position detection apparatus 80 can be mounted on a head-mounted display as, for example, an eye tracking apparatus, and can detect or track the direction of the user's line of sight. In this case, for example, the resolution of an image displayed in a region near the direction of the user's line of sight in other regions is reduced (i.e., foveal rendering) so that the image processing can be speeded up as compared with the case where a high-resolution image is displayed in the entire region.

The pupil-or-cornea position detection apparatus 80 illustrated in FIG. 29 includes a light source 82, first light deflectors 83-1-4, a lens 92, a lens 93, a scanning mirror 94, a deflecting mirror 95, a second light deflector 85, a light receiver 86, and a controller 96. The light source 82, the first optical deflectors 83-1-4, the second light deflector 85, and the light-receiver 86 have similar structure to the configuration described in FIG. 28, so the description is omitted.

The lens 92 is an optical system that converts the light emitted by light source 82 into an abbreviated collimated light. The lens 93 is an optical system that forms the light converted by the lens 92 into the desired laser beam state. In this embodiment, the pupil-or-cornea position detection apparatus 80 includes both the lens 92 and the lens 93. However, it is not necessary that the pupil-or-cornea position detection apparatus 80 include the lens 92 or the lens 93.

The light formed by the lens 92 and the lens 93 enters the scanning mirror 94 (movable device 13). The scanning mirror 94 scans the incident light to form image light. The formed image light is incident on the deflecting mirror 95 and reflected in the direction toward the second light deflector 85. The deflecting mirror 95 corresponds to the first light deflector 83-5 illustrated in FIG. 28, but it is preferable to have a structure that can run light with a movable device 13. To make the deflecting mirror 95 a light-scannable configuration the image can be projected over a wider area.

Although, the deflecting mirror 95 illustrated in FIG. 29 is disposed between the scanning mirror 94 and the second optical deflector 85, the arrangement of the deflecting mirror 95 and the scanning mirror 94 is not limited to this. For example, the scanning mirror 94 is disposed between the deflecting mirror 95 and the second light deflecting section 85, and the light reflected by the deflecting mirror 95 is scanned in the 2-axis direction by the scanning mirror 94. The controller 96 also controls the luminescence and light intensity of the light source 82 by giving the formation drive signal SL1 to the light source 82 and drives the scanning mirror 94 by giving the scanning drive signal SS to the scanning mirror 94. If the deflecting mirror 95 is configured for optical scanning, the controller 96 gives the deflection drive signal ST to the deflecting mirror 95 to drive the deflection mirror 95 in order to control the image projection position according to the acquired gaze information.

As described above, preferable embodiments have been described in detail. However, embodiments according to the present disclosure are not limited to the embodiments described above, and various modifications and substitutions can be made to the above-described embodiments of the present disclosure without departing from the scope of the claims.

All the numerals such as ordinal numbers and numbers and reference symbols used in the description of the embodiments are illustrative for specifically describing the technique of the present invention, and the present invention is not limited to the illustrated numerals. In addition, a coupling relation between the components is an example for specifically describing the technology of the present disclosure, and a connection relation for implementing a function of the present disclosure is not limited thereto.

The functionality of the elements disclosed herein may be implemented using circuitry or processing circuitry which includes general purpose processors, special purpose processors, integrated circuits, ASICs (“Application Specific Integrated Circuits”), FPGAs (“Field-Programmable Gate Arrays”), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

1. A movable device comprising:
a movable portion;
a driver to drive the movable portion;
a first connect beam extending from the movable portion in a direction intersecting a centerline of the movable portion;
a second connect beam extending from the driver in a direction intersecting the centerline of the movable portion; and
an intermediate connector extending in a direction along the centerline and connecting the first connect beam and the second connect beam.

2. The movable device according to claim 1, wherein:
the intermediate connector is columnar; and
the intermediate connector extends in a direction along the centerline.

3. The movable device according to claim 2, wherein:
the driver includes:
a piezoelectric portion; and
a base connected to the second connect beam,
the piezoelectric portion is disposed on one side of the base in the direction along the centerline, and
the intermediate connector extends from the second connect beam to a side opposite to the piezoelectric portion.

4. The movable device according to claim 3, further comprising:
a support which includes a frame to support a plurality of the drivers,
wherein:
the movable portion is disposed inside the support as viewed along the centerline,
the base extends inwardly from the support as viewed along the centerline,
the support has a predetermined length in the direction along the centerline, and
the movable portion is disposed inside the support as viewed along the centerline.

5. The movable device according to claim 1, further comprising:
a first support panel,
wherein the first connect beam includes:
a pair of beams extending in the longitudinal direction of the first connect beam, and disposed apart in the width direction that intersects the longitudinal direction of the first connect beam; and
a pair of support beams extending inwardly from each other from the pair of beams,
wherein:
the first support panel connects with the pair of support beams, and
the intermediate connector is connected to the first support panel.

6. The movable device according to claim 1, further comprising:
a second support panel,
wherein the second connect beam includes:
a pair of beams extending in the longitudinal direction of the second connect beam, and disposed apart in the width direction that intersects the longitudinal direction of the second connect beam; and
a pair of support beams extending inwardly from each other from the pair of beams,
wherein:
the second support panel connects with the pair of support beams, and
the intermediate connector is connected to the second support panel.

7. The movable device according to claim 1, wherein the intermediate connector includes:
a first intermediate connector;
a second intermediate connector; and
a third connect beam,
wherein the first intermediate connector and the second intermediate connector are connected via a third connect beam.

8. The movable device according to claim 1, wherein the movable portion includes:
a reflective surface;
a movable base including the reflective surface; and
a rear-side connector disposed on a rear side of the movable base, which is opposite side of the reflective surface,
wherein:
the rear-side connector is connected to the first connector, and
a diameter of the reflective surface is larger than a diameter of the rear-side connector.

9. The movable device according to claim 8, wherein the movable portion includes:
a rear-side overhang portion extending from the rear side of the movable base in a direction along the centerline,
wherein the rear-side overhang portion is connected to the first connect beam via the rear-side connector.

10. An image projection apparatus comprising:
a light scan system including the movable device according to claim 1.

11. A moving body comprising:
the image projection apparatus according to claim 10.

12. A head-mounted display comprising:
the movable device according to claim 1.

13. A head-up display comprising:
the movable device according to claim 1.

14. A laser headlamp comprising:
the movable device according to claim 1.

15. An object recognition apparatus comprising:
the movable device according to claim 1.

16. An eye tracking apparatus comprising:
the movable device according to claim 1.

17. A device comprising:
a mirror;
a driver to drive the mirror;
a first connect beam extending from the mirror in a direction intersecting a centerline of the mirror;
a second connect beam extending from the driver in a direction intersecting the centerline of the mirror; and
an intermediate connector extending in a direction along the centerline and connecting the first connect beam and the second connect beam.

18. The device according to claim 17, wherein:
the intermediate connector is columnar; and
the intermediate connector extends in a direction along the centerline.

19. The device according to claim 18, wherein:
the driver includes:
a piezoelectric portion; and
a base connected to the second connect beam,
the piezoelectric portion is disposed on one side of the base in the direction along the centerline, and
the intermediate connector extends from the second connect beam to a side opposite to the piezoelectric portion.

20. The device according to claim 19, further comprising:
a support which includes a frame to support a plurality of the drivers,
wherein:
the mirror is disposed inside the support as viewed along the centerline,
the base extends inwardly from the support as viewed along the centerline,
the support has a predetermined length in the direction along the centerline, and
the movable portion is disposed inside the support as viewed along the centerline.
